(19) United States
(12) Patent Application Publication
(10) Pub. No.: US 2014/0233970 A1
(43) Pub. Date: Aug. 21, 2014

(54) IMAGE FORMING APPARATUS

(71) Applicant: CANON KABUSHIKI KAISHA, Tokyo (JP)

(72) Inventor: Isao Hayashi, Kawasaki-shi (JP)

(73) Assignee: CANON KABUSHIKI KAISHA, Tokyo (JP)

(21) Appl. No.: 14/182,836

(22) Filed: Feb. 18, 2014

(30) Foreign Application Priority Data
Feb. 19, 2013 (JP) 2013-029574

(51) Int. Cl. G03G 15/01

(52) U.S. Cl. CPC G03G 15/5054
USPC 399/40

(57) ABSTRACT

Latent image graduations formed on an intermediate transfer belt are read by a first sensor portion. Latent image graduations formed on a photoconductive drum are read by a second sensor portion. When an image is transferred from the photoconductive drum to the intermediate transfer belt on the basis of the information read by these sensor portions, the position of the image on the photoconductive drum is controlled to match the position of the image on the intermediate transfer belt. The first sensor portion and the second sensor portion are held integrally by the holding member. Accordingly, variations due to a temperature change of relative positions between the sensor portions or difference in vibrations of the respective sensor portions which may cause errors when aligning the images are reduced.

### BACKGROUND OF THE INVENTION

1. Field of the Invention

This disclosure relates to an image forming apparatus such as a copying machine, a printer, a facsimile, and a multiple function processing machines having functions of these apparatuses.

2. Description of the Related Art

In an electrophotographic color image forming apparatus, various types of a so-called tandem type image forming apparatuses including a plurality of image forming portions are provided for achieving high-speed processing, and transferring images of different colors in sequence on a recording medium held on an intermediate transfer belt or a conveying belt are proposed.

However, the tandem type color image forming apparatus of this type have problems described below. In other words, due to lack of mechanical accuracy, difference in amounts of movement between outer peripheral surfaces of photoconductive drums and the intermediate transfer belt at transfer positions of respective image forming portions occurs discretely from one color to another by variation in speed of a plurality of the photoconductive drums and the intermediate transfer belt. Therefore, when superimposing images, a color shift may arise among respective colors.

Accordingly, a structure for suppressing such a color shift has been proposed in the related art. For example, in JP-A-2009-134264 and JP-A-2004-145077, image positional information provided on an intermediate transfer belt and image positional information provided on photoconductive drums are read by information detecting portions provided separately. Then, the respective image forming portions are controlled so that an image formed on a first photoconductive drum on the upstream of the intermediate transfer belt in the direction of conveyance and transferred to the intermediate transfer belt and an image formed on a second photoconductive drum on the downstream in the direction of conveyance are aligned. As image positional information, electrostatic latent images or a magnetic recording system are employed.

In the case of the structures disclosed in JP-A-2009-134264 and JP-A-2004-145077 described above, information detecting portions for photoconductive drums and information detecting portion for the intermediate transfer belt are individually provided. In other words, the information detecting portions are provided separately. Therefore, variations due to a temperature change of relative positions between the information detecting portions or difference in vibrations of the respective information detecting portions may cause errors when aligning the images.

### SUMMARY OF THE INVENTION

This disclosure provides an image forming apparatus including a conveying member configured to carry and convey an image or a recording medium, a first image carrier and a second image carrier arranged in a direction of conveyance of the conveying member and each configured to carry and convey an image, a first image forming portion configured to form an image on the first image carrier, a second image forming portion configured to form an image on the second image carrier, a first transfer portion configured to transfer an image from the first image carrier to the conveying member or the recording medium conveyed by the conveying member, a second transfer unit arranged downstream of the first transfer portion in the direction of conveyance of the conveying member, and configured to transfer an image from the second image carrier to the conveying member or the recording medium conveyed by the conveying member, a first positional information forming unit configured to form first positional information relating to a position of the image formed by the first image forming portion on the conveying member, a second positional information forming unit configured to form second positional information relating to a position of the image formed by the second image forming portion on the second image carrier, a first information detecting portion arranged so as to incline with respect to the direction of conveyance of the conveying member and configured to detect the first positional information formed on the conveying member, a second information detecting portion arranged so as to incline with respect to the direction of conveyance of the second image carrier and configured to detect the second positional information formed on the second image carrier, a control portion configured to control at least any one of the second image carrier, the second image forming member, and the conveying member such that the position of the image carried on the second image carrier match the position of the image transferred from the first image carrier to the conveying member or the image transferred from the first image carrier to the recording medium conveyed by the conveying member the image is transferred from the second image carrier to the conveying member or the recording medium conveyed by the conveying member on the basis of the first positional information detected by the first information detecting portion and the second positional information detected by the second information detecting portion and a holding member arranged so as to be interposed between the second image carrier and the conveying member and configured to hold the first information detecting portion and the second information detecting portion integrally.

Further features of the present invention will become apparent from the following description of exemplary embodiments with reference to the attached drawings. The accompanying drawings, which are incorporated in and constitute apart of the specification, illustrate exemplary embodiments, features, and aspects of the invention and, together with the description, serve to explain the principles of the invention.

### BRIEF DESCRIPTION OF THE DRAWINGS

FIG. 1A is a schematic perspective view illustrating a configuration of an image forming apparatus of a first embodiment of this disclosure.

FIG. 1B is a schematic cross-sectional view illustrating a configuration of a periphery of a second image forming portion in an enlarged graduation.

FIG. 1C is a schematic perspective view illustrating a configuration of a transfer structure for transferring latent image graduations on a first image forming portion according to another example.

FIG. 2A is a schematic drawing illustrating a potential relationship between a probe and a graduation of relative positions for explaining a principle of detection of a latent image graduation by a latent image detecting probe of the first embodiment.

FIG. 2B is a schematic drawing illustrating a state in which the probe and the graduation get close to each other after a predetermined time period has elapsed from the state illustrated in FIG. 2A.

FIG. 2C is a schematic drawing illustrating a state in which the probe moves on the graduation after a predetermined time period has elapsed from the state illustrated in FIG. 2B.

FIG. 2D is a schematic drawing illustrating a state in which the probe and the graduation move away from each other after a predetermined time period has elapsed from the state illustrated in FIG. 2C.

FIG. 2E is a drawing illustrating an output signal that the probe has detected in the case where the width of the graduation is wide.

FIG. 2F is a drawing illustrating an output signal that the probe has detected in the case where the width of the graduation is narrow.

FIG. 3A is a plan view schematically illustrating a configuration of a latent image sensor of the first embodiment.

FIG. 3B is a cross-sectional view of the latent image sensor of FIG. 3A.

FIG. 3C is a connecting chart of an amplifying electric circuit of the latent image sensor illustrated in FIG. 3A.

FIG. 4 is a perspective view schematically illustrating a three-dimensional positional relationship among a signal detecting portion of the latent image sensor, the graduations on the photoconductive drum, and the graduations on the intermediate transfer belt according to the first embodiment.

FIG. 5A is a schematic drawing illustrating a state in which the latent image sensor according to the first embodiment detects the graduations on the intermediate transfer belt.

FIG. 5B is a schematic drawing illustrating a state in which the latent image sensor according to the first embodiment detects the graduations on the photoconductive drum.

FIG. 6 is a drawing illustrating a relationship of a relative angle between the signal detecting portion of the latent image sensor and the graduations with an output signal.

FIG. 7 is a schematic drawing illustrating a relationship between the signal detecting portion and the graduations for obtaining the relationship in FIG. 6.

FIG. 8A is a drawing schematically illustrating the state of installation of the latent image sensor of the first embodiment, viewed in a sub scanning direction.

FIG. 8B is a cross-sectional view illustrating the state of installation of the latent image sensor of FIG. 8A viewed in a main scanning direction.

FIG. 8C is a schematic plan view illustrating the configuration of the latent image sensor of the first embodiment.

FIG. 8D is a cross-sectional view of the latent image sensor of FIG. 8C.

FIG. 9A is a drawing schematically illustrating a state in which the graduations on the photoconductive drum are detected by the latent image sensor of the first embodiment.

FIG. 9B is a drawing illustrating a potential state of the graduations in FIG. 9A.

FIG. 9C is a drawing illustrating an output signal when the graduations in FIG. 9A is detected by the latent image sensor.

FIG. 10 is a schematic drawing illustrating control for reducing a color shift of the first embodiment with reference to a relation between the two image forming portions.

FIG. 11 is a flowchart of control configured to reduce the color shift of the first embodiment.

FIG. 12 is a schematic plan view illustrating the configuration of the latent image sensor of the second embodiment of this disclosure.

FIG. 13A is a schematic drawing illustrating a state in which the latent image sensor according to the second embodiment detects the graduations on the intermediate transfer belt.

FIG. 13B is a schematic drawing illustrating a state in which the latent image sensor according to the second embodiment detects the graduations on the photoconductive drum.

FIG. 14 is a schematic plan view illustrating the configuration of the latent image sensor according to a third embodiment of this disclosure.

FIG. 15A is a schematic drawing illustrating a state in which the latent image sensor according to the third embodiment detects the graduations on the photoconductive drum.

FIG. 15B is a schematic drawing illustrating a state in which the latent image sensor according to the third embodiment detects the graduations on the intermediate transfer belt.

FIG. 16 is a schematic drawing illustrating a state in which the latent image sensor detects the graduations on the photoconductive drum and graduations on the intermediate transfer belt having no shift in the main scanning direction and the sub scanning direction in the third embodiment.

FIG. 17A is a schematic drawing illustrating a state in which the latent image sensor detects the graduations on the photoconductive drum and graduations on the intermediate transfer belt shifted in the sub scanning direction in the third embodiment.

FIG. 17B is a schematic drawing illustrating a state after the lapse of predetermined time from the state of FIG. 17A.

FIG. 18A is also a schematic drawing illustrating a state in which the latent image sensor detects the graduations on the photoconductive drum and graduations on the intermediate transfer belt shifted in the main scanning direction.

FIG. 18B is a schematic drawing illustrating a state after the lapse of predetermined time from the state of FIG. 18A.

FIG. 18C is a schematic drawing illustrating a state after the lapse of predetermined time from the state of FIG. 18B.

FIG. 19 is a schematic drawing illustrating a state of a shifted distance when the latent image sensor detects the graduations on the intermediate transfer belt shifted in the main scanning direction in the third embodiment.

FIG. 20 is a schematic plan view illustrating the configuration of the latent image sensor according to a fourth embodiment of this disclosure.

### DESCRIPTION OF THE EMBODIMENTS

### First Embodiment

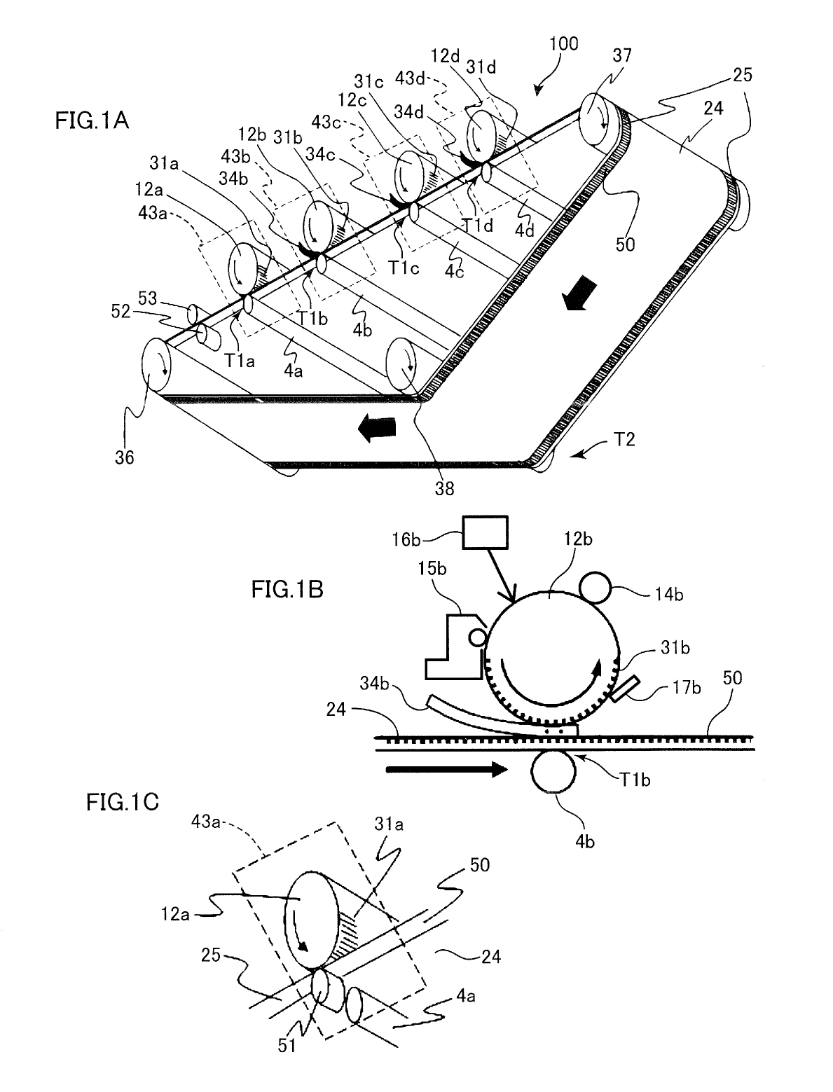

Referring now to FIG. 1 to FIG. 11, a first embodiment of this disclosure will be described. First of all, with reference to FIG. 1A, a schematic configuration of an image forming apparatus of the first embodiment will be described.

### <Image Forming Apparatus>

An image forming apparatus 100 of the first embodiment is a so-called tandem type image forming apparatus in which a plurality of image forming portions 43a, 43b, 43c, and 43d are arranged side by side in a traveling direction (direction of conveyance) of the intermediate transfer belt 24 as a conveying member. In the image forming portions 43a, 43b, 43c, and 43d, toner images in yellow, magenta, cyan, and black are formed, respectively. Although detailed illustration will be omitted in FIG. 1A, the respective image forming portions include photoconductive drums 12a, 12b, 12c and 12d as image carriers, and are configured to form toner images in respective colors on respective photoconductive drums.

The toner images formed on the photoconductive drums 12a, 12b, 12c and 12d respectively are transferred to the intermediate transfer belt 24 to be superimposed on one on top of another at respective primary transfer portion T1a, T1b, T1c, and T1d, so that a full color toner image is formed. The intermediate transfer belt 24 is extended around a drive roller 36, a driven roller 37, and a secondary transfer roller 38 in a stretched manner, and is configured to travel in the direction indicted by arrows in the drawing by the drive roller 36 being driven by a motor, which is not illustrated. The toner images formed on the intermediate transfer belt 24 is transferred to a recording medium such as a sheet or an OHP sheet at a secondary transfer portion T2. The recording medium is conveyed to the secondary transfer portion T2 synchronously with the toner image transferred to the intermediate transfer belt 24 by a recording medium conveying device, not illustrated.

A configuration of the image forming portion will be described with the image forming portion 43b as an example with reference to FIG. 1B. The configuration of the respective image forming portions are substantially the same except that toner colors are different, and a latent image sensor, which will be described later, is not provided on the image forming portion 43a, which is the upstreammost. When performing image formation, a surface of the photoconductive drum 12b is charged to a predetermined potential by the charging roller 14b as a charger. Subsequently, a laser beam is radiated from an exposure device (a second exposure device) 16b as an exposure unit on the basis of image information, so that an electrostatic latent image is formed on the surface of the photoconductive drum 12b. Subsequently, the electrostatic latent image is developed with toner by the developing device 15b as a developing unit, so that a toner image is formed on the surface of the photoconductive drum 12b. The toner image is primarily transferred to the intermediate transfer belt 24 by a predetermined primary transfer bias applied between the primary transfer roller 4b as a transfer portion arranged at a position opposing the photoconductive drum 12b with the intermediate transfer belt 24 interposed therebetween and the photoconductive drum 12b. The toner remaining on the surface of the photoconductive drum 12b after the primary transfer is removed by a cleaning device 17b.

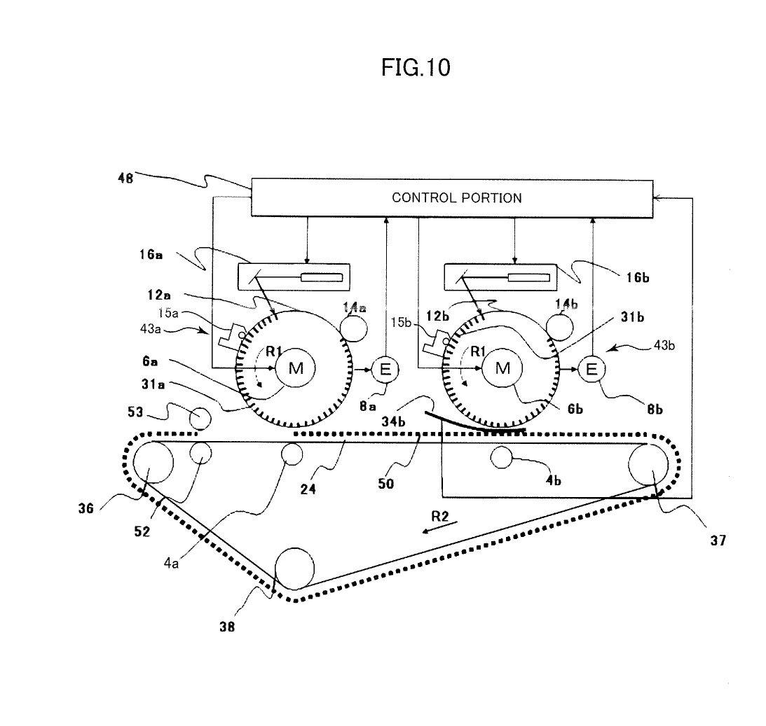

The image forming portion is composed of the charging roller 14b, an exposure unit 16b, and the developing device 15b. Referring also to FIG. 10, the charging roller 14a of the image forming portion 43a corresponds to a first charging unit, the exposure unit 16a (first exposure device) corresponds to a first exposure unit, and the developing device 15a corresponds to a first developing device, respectively, and these members constitute a first image forming portion. In each of the image forming portions 43b, 43c, and 43d, the charging roller corresponds to a second charging unit, the exposure device corresponds to a second exposure unit, and the developing device corresponds to a second developing device, respectively, and these members constitute a second image forming portion. A primary transfer roller 4a of the image forming portion 43a corresponds to a first transfer portion, primary transfer rollers 4b, 4c and 4d of the image forming portions 43b, 43c, and 43d correspond to the second transfer portions, respectively.

### <Image Positional Information>

In this manner, the toner images in respective colors are formed at the respective image forming portions and are transferred so as to superimpose one on top of another on the intermediate transfer belt 24. At this time, positional information on the position of the image is formed on the intermediate transfer belt 24 and on the respective photoconductive drums to align the positions of the toner images in the respective colors at the respective primary transfer portions, and the positional information is detected to achieve registration of the images and reduce the color shift. In the first embodiment, latent image graduations formed of latent images are employed as the positional information described above. In the case of the first embodiment, the latent image graduations on the intermediate transfer belt 24 are formed by the latent image graduations formed on the photoconductive drum 12a as a first image carrier positioned on the upstreammost by being transferred to the intermediate transfer belt 24. In contrast, the latent image graduations of the photoconductive drums 12b, 12c and 12d as second image carriers on the downstream of the photoconductive drum 12a in the direction of conveyance of the intermediate transfer belt 24 are not transferred to the intermediate transfer belt 24.

Such a latent image graduations are formed on non-image areas deviated from image forming areas in which the toner images are formed. In other words, the non-image areas are areas on surfaces of the photoconductive drums 12a to 12d and the intermediate transfer belt 24 deviated from the image forming areas in a width direction intersecting the direction of conveyance of the photoconductive drums and the intermediate transfer belt. In the first embodiment, the non-image areas are both end portions of the photoconductive drums and the intermediate transfer belt in the width direction, respectively. The latent image graduations 50 formed in a non-image areas 25 of the intermediate transfer belt 24 correspond to first positional information, and latent image graduations 31b, 31c, and 31d formed on the photoconductive drums 12b, 12c and 12d correspond to second positional information. The latent image graduations 31a formed on the photoconductive drum 12a correspond to the first positional information, and the latent image graduations 50 are formed by the latent image graduations 31 transferred to the intermediate transfer belt 24.

An erasing roller 53 and a counter electrode 52 as erasing portions configured to erase the latent image graduations 50 formed on the intermediate transfer belt 24 are arranged on the upstream of the photoconductive drum 12a in the direction of conveyance of the intermediate transfer belt 24. The erasing roller 53 is arranged so as to come into contact with the non-image areas 25 of the intermediate transfer belt 24, and a predetermined erasing bias is applied between the erasing roller 53 and the counter electrode 52, whereby the latent image graduations 50 formed in the non-image areas 25 are erased.

The non-image areas 25 in which the latent image graduations 50 are formed are formed of a high-resistivity material having a volume resistivity of 10¹⁴ Ω·cm or higher laminated on end portions on the front surface or on aback surface of the intermediate transfer belt 24. The high-resistivity material as described above may be any material as long as it can be formed on the intermediate transfer belt and, for example, resin materials such as PTFE (polytetrafluoroethylene), PET (polyethylene terephthalate), polyimide, and the like may be employed. The latent image graduations 50 transferred to the non-image areas 25 described above are retained at least until reaching the photoconductive drum 12d on the downstreammost.

### <Formation of Latent Image Graduations>

A method of forming the latent image graduations 50 will be described in detail. When forming the toner image on the surface of the photoconductive drum at the image forming portion 43a, the electrostatic latent image graduations 31a is formed by irradiation with a laser beam before and after writing the image by the exposure device in the non-image areas out of the image forming area on the photoconductive drum 12a. Then, the electrostatic latent image graduations 31a come into contact with the non-image areas provided at the both end portions on the surface of the intermediate transfer belt 24 at the primary transfer portion T1a. At this time, the toner image is transferred to the image forming area on the intermediate transfer belt 24 by the primary transfer roller 4a extended to the non-image areas and for transferring toner charged at a primary transfer bias (potential Vt). At the same time, part of electric charge that forms the electrostatic latent image graduations 31a is transferred to the non-image areas 25 and the electrostatic latent image graduations 50 are transferred. Therefore, in the case of the first embodiment, a first positional information forming unit for forming the latent image graduations 50 as the first positional information on the intermediate transfer belt 24 includes an exposure device and the primary transfer roller 4a of the image forming portion 43a. At this time, the exposure device of the image forming portion 43a corresponds to the first positional information forming portion, and the primary transfer roller 4a corresponds to an information transfer portion. In the first embodiment, the primary transfer roller 4a serves also as the information transfer portion.

The first positional information forming unit forms the latent image graduations 31a by arranging a plurality of first lines inclined at substantially the same first angle with respect to the direction of conveyance of the photoconductive drum 12a in the direction of conveyance of the photoconductive drum 12a by the exposure device that serves as the first positional information forming portion. In other words, the plurality of the first lines are formed of electrostatic latent images, which correspond to the latent image graduations 31a as the first positional information described above. The latent image graduations 31a formed in this manner are transferred to the intermediate transfer belt 24 by the primary transfer roller 4a, and the latent image graduations 50 are formed.

The exposure unit 16b which also serves as a second positional information forming unit forms the latent image graduations 31b by arranging a plurality of second lines not in parallel with the above-described first lines and inclined at substantially the same second angle with respect to the direction of conveyance of the photoconductive drum 12b in the direction of conveyance of the photoconductive drum 12b. In other words, the plurality of second lines are formed in the form of electrostatic latent images, which correspond to the latent image graduations 31b as the second positional information described above. Description of the latent image graduations 50 composed of the plurality of the first lines and the latent image graduation 31b composed of the plurality of the second lines will be given later.

The non-image area of the photoconductive drum 12a in which the electrostatic latent image graduations 31a are to be formed may be one side of the drum or both side of the drum. When setting the bias to be applied for toner transfer and for latent image graduations transfer independently, a latent image transfer roller 51 for transferring the latent image graduations may be provided separately from and coaxially with the primary transfer roller 4a for toner as illustrated in FIG. 1C. In this case, the latent image transfer roller 51 corresponds to the information transfer portion.

In contrast, in the image forming portion 43b illustrated in FIG. 1A, a latent image sensor 34b configured to read the latent image graduations is used to read both of the latent image graduations 31b on the photoconductive drum 12b and the latent image graduations 50 on the non-image areas 25 provided on the intermediate transfer belt 24. FIG. 1B is a cross-sectional view of the image forming portion 43b viewed from an axial direction of the photoconductive drum, and the latent image sensor 34b is arranged so as to be held at a nip position between the photoconductive drum 12b and the intermediate transfer belt 24. In the same manner in the image forming portions 43c and 43d, the latent image sensor 34c and 34d are arranged so as to be held at nip positions between the photoconductive drums 12c and 12d and the intermediate transfer belt 24, respectively. Detailed description about the structure of the latent image sensors 34b, 34c, and 34d will be later, and the control for performing correction of the positional shift (the color shift) of the image by reading the latent image graduations 31b and 50 with the latent image sensor will be briefly described below.

### <Color Shift Correction>

When forming a color toner image on the intermediate transfer belt 24, a color shift correction is performed for each color. Therefore, a potential change of the latent image graduations corresponding to the toner image are read by a latent image detection probe in the latent image sensor 34b and the shift amount between the graduations on the drum and the belt is calculated. Subsequently, the photoconductive drum 12b is controlled so that the positions of the graduations on the drum and the belt are aligned according to the calculated shift amount. In other words, the photoconductive drum 12b is controlled so as to align the toner image to be formed on the intermediate transfer belt 24 from the photoconductive drum 12 of the image forming portion 43b with a toner image formed on the intermediate transfer belt 24 at the image forming portion 43a.

Subsequently, the same detection is performed at the image forming portions 43c and 43d in FIG. 1A, and then the photoconductive drums 12c and 12d are controlled with respect to the intermediate transfer belt 24 so as to always align the positions of the graduations of the corresponding drum and the belt immediately before the toner transfers.

The erasing roller 53 configured to erase the graduations and the counter electrode 52 are installed so as to initialize the belt potential in the non-image areas 25 in which the latent image graduations on the intermediate transfer belt are provided, and is configured to apply an AC potential and a DC potential in an superimposed manner. The erasing roller 53 and the counter electrode 52 are used for erasing the previously transferred latent image graduations, that is, for floating and smoothing up and down of the potential on the belt, and are compatible with sinusoidal waves, rectangular waves, and pulsed waves.

The positions of the erasing roller 53 and the counter electrode 52 may be at any positions between the image forming portion 43d on the downstreammost position and the image forming portion 43a on the upstreammost position. In order to reduce probability of a change in the potential state on the belt surface due to the influence of external noise or the like during the conveyance of the intermediate transfer belt, the erasing roller 53 and the counter electrode 52 are preferably placed immediately before the image forming portion 43a at the upstreammost position. Other portions such as a corona charger may be used for erasing the latent image graduations.

In the configuration described above, the amount corresponding to the color shift of the toner image on the intermediate transfer belt may be corrected with high degree of accuracy by using the latent image graduations on the drum and the belt, so that a color image forming apparatus with less amount of the color shift is provided. Whether the latent image graduations 50 are transferred to the front surface side of the intermediate transfer belt 24 or to the back surface side of the intermediate transfer belt 24 may be selected depending on the characteristics and product specifications of the latent image process including the photoconductive drums and the intermediate transfer belt.

### <Latent Image Graduations Detection Principle>

Subsequently, a latent image graduations detection principle on the basis of the usage of the latent image sensor will be described with an example of detection at the image forming portion 43b. The latent image sensor has a latent image detecting probe 330 formed of a conductor such as copper (hereinafter, simply referred to as a probe 330, which corresponds to the first and second signal detecting portions 333 and 335 described later). Since the description of the detection principle will be given here, graduations and a probe perpendicular to the direction of rotation of the drum will be described.

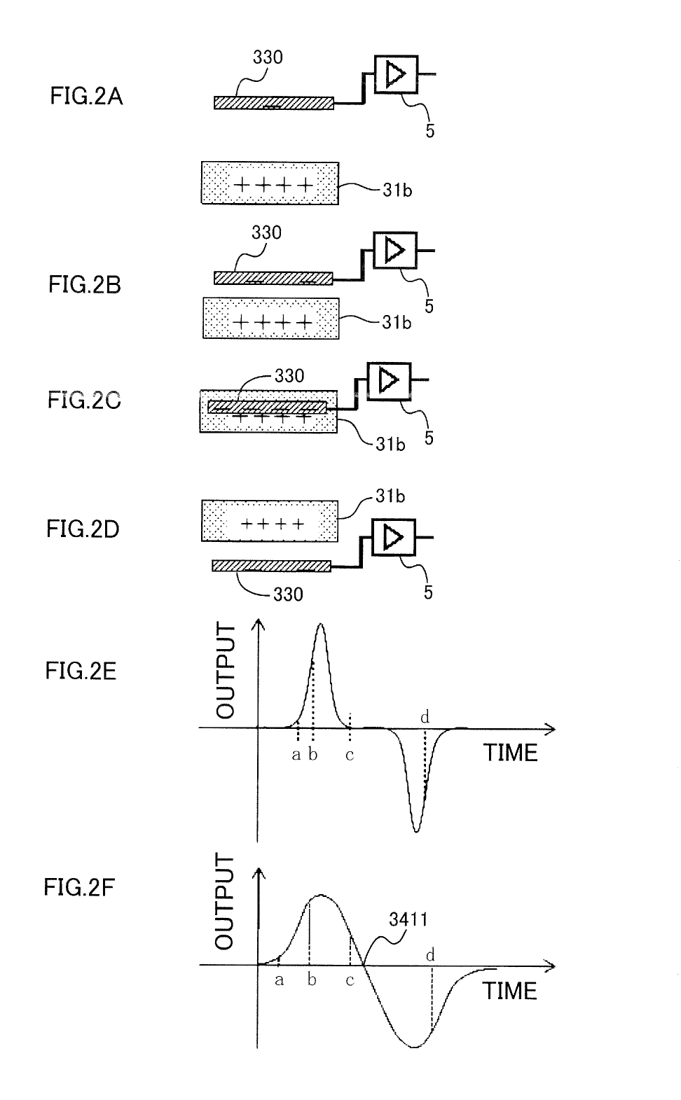

In FIGS. 2A to 2F, only one of the latent image graduation 31b is illustrated. The probe 330 is connected to the amplifying electric circuit 5 for detection. The latent image graduation 31b exists on the surface of the photoconductive drum 12b as a potential difference, and the probe 330 is installed at a position just a little (several μm to several tens of μm) apart from the surface of the photoconductive drum 12b. In FIG. 2A to 2F, the probe 330 and the latent image graduation 31b move relative to each other temporary in order of FIG. 2A, FIG. 2B, FIG. 2C and FIG. 2d. At the time of relative movement, the probe 330 moves in a state of maintaining the distance from the surface of the photoconductive drum 12b constant. In FIG. 2A to 2D, the potential of the latent image graduation 31b are indicated by + signs because a case where the potential of the periphery is charged at −500V and the latent image graduation 31b is charged at −100V is assumed.

First of all, in FIG. 2A, when the probe 330 gets close to the latent image graduation 31b, free electrons in an electric wiring to the probe 330 and the amplifying electric circuit 5 are attracted by a positive potential of the latent image graduations 31b by a little amount. Subsequently, in FIG. 2B, the probe 330 gets close to the latent image graduations 31b, and the amount of the free electrons to be attracted is increased. Subsequently, in FIG. 2C, the probe 330 takes a position closest to the latent image graduations 31b, at which the attracted amount of the free electrons is maximized. Finally, in FIG. 2D, the probe 330 starts to be separated from the latent image graduation 31b, and then the attracted free electrons start to return. By detecting this flow of the free electrons (induced current) by the amplifying electric circuit 5 and outputting therefrom, the positions of each of the latent image graduation 31b is allowed to be taken out as an electric signal. The output from the amplifying electric circuit 5 at this time is plotted as graphs in FIGS. 2E and 2F.

The difference between FIG. 2E and FIG. 2F is caused by various conditions such as “the width of the probe 330, the width of the latent image graduation 31b, the distance between the probe 330 and the latent image graduations 31b, and a relative speed between the probe 330 and the latent image graduation 31b”. When the width of the latent image graduation 31b is wide, the waveform illustrated in FIG. 2E is achieved. The more the width of the latent image graduation 31b is narrowed, the more the waveform becomes closer to the waveform illustrated in FIG. 2F. The waveform will be described. The amount of output is increased with a reduction of the distance between the probe 330 and the latent image graduation 31b, and the induced current becomes zero instantaneously when the probe 330 and the latent image graduation 31b overlap (get closest) with each other (zero-cross point 3411 in FIG. 2F). The output decreases with an increase in distance between the probe 330 and the latent image graduation 31b, and then the output signal reaches zero in due course. The zero-cross point 3411 corresponds to a moment when the probe 330 passes right above the latent image graduations 31b. The detection principle for detecting the latent image graduation 31b by using the probe 330 will be described thus far.

### <Latent Image Sensor>

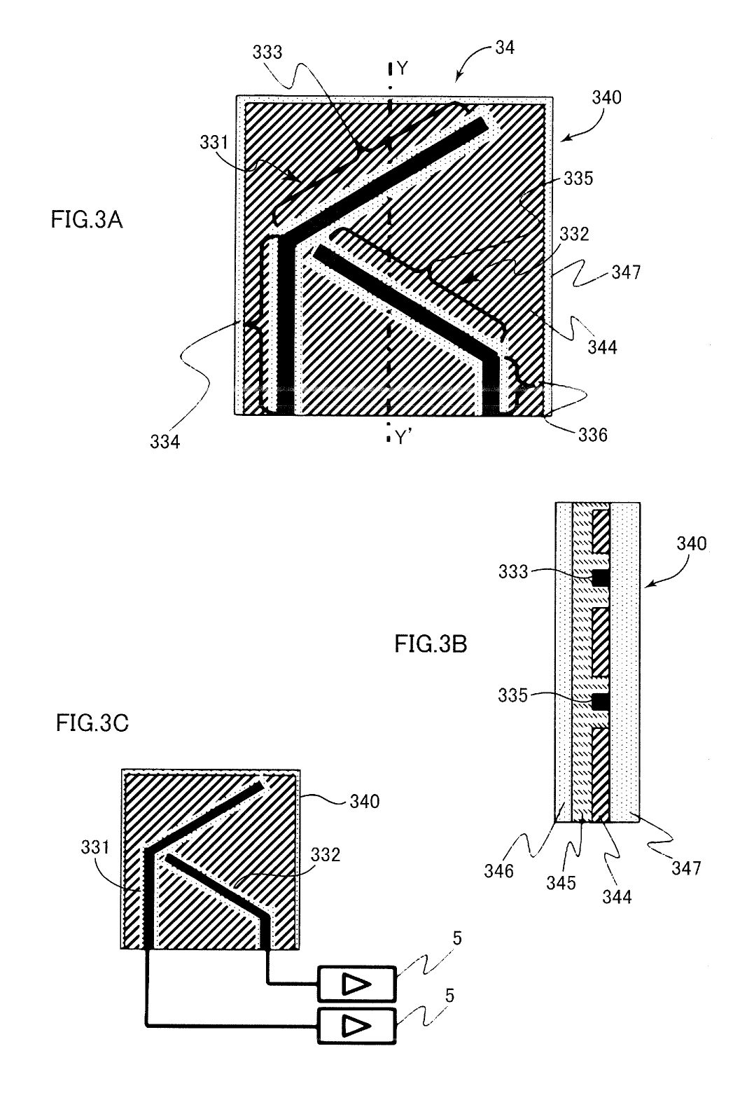

Subsequently, a detailed configuration of the latent image sensor as described above will be described. Since the latent image sensors 34b, 34c, and 34d have the same configuration, subscripts to be added to reference numbers for indicating the image forming portions that the components belong to will be omitted in the description give below unless otherwise specifically required. In the first embodiment, the latent image sensor 34 is formed by using a flexible printed board. The configuration of the latent image sensor 34 will be described in FIGS. 3A to 3C. The latent image sensor 34 in FIGS. 3A to 3C is a “a single layer flexible printed board” used normally in wiring of the electric apparatus, and constitutes a portion for detecting the latent image as the positional information by a copper pattern thereof. In other words, a holding member 340 described later includes the first and second signal detecting portions 333 and 335 held in the same layer. In the following description, an example of the flexible printed board will be described. However, any material may be used as long as the same configuration (in terms of a relationship between a conductor and an insulating member) is achieved. FIG. 3A is a plan view, and FIG. 3B is a cross-sectional view taken along a plane Y-Y′.

The latent image sensor 34 includes a first sensor portion 331 and a second sensor portion 332. The first sensor portion 331 includes a first signal detecting portion 333 as first information detecting portion and a first signal transmitting portion 334. The second sensor portion 332 includes a second signal detecting portion 335 as second information detecting portion and a second signal transmitting portion 336. The first signal detecting portion 333 and the second signal detecting portion 335 correspond to the probe 330 described above, and are configured to detect the latent image graduations 31 and 50. The first signal transmitting portion 334 and the second signal transmitting portion 336 are portion configured to transmit the detected signals. The first signal detecting portion 333 and the second signal detecting portion 335, and the first signal transmitting portion 334 and the second signal transmitting portion 336 are formed of a conductor, and in the case of the first embodiment, are formed by copper patterns described above. The first signal detecting portion 333 is arranged so as to incline by a first angle with respect to the direction of conveyance of the intermediate transfer belt 24, and the second signal detecting portion 335 is arranged so as to incline by a second angle with respect to the direction of conveyance (direction of rotation) of the photoconductive drum 12. The amplifying electric circuits 5 are connected respectively to the first sensor portion 331 and the second sensor portion 332, and the amplifying electric circuits 5 amplify and output the detected signals as illustrated in FIG. 3C.

The first sensor portion 331 and the second sensor portion 332 are configured to detect the changes of the signals, described with reference to FIG. 2, which are output when the first line and the second line pass through positions opposing the first and second signal detecting portions 333 and 335. Accordingly, the first sensor portion 331 and the second sensor portion 332 read the latent image graduations 31 and 50.

The latent image sensor 34 has a layer structure as illustrated in FIG. 3B, and is configured to hold the first sensor portion 331 and the second sensor portion 332 integrally therewith by the holding member 340. The holding member 340 includes a substrate 347 on which the first and the second signal detecting portions 333 and 335 and the first and the second signal transmitting portions 334 and 336 are printed, a film type cover 346 configured to cover the surface of the substrate 347, and an adhesive agent 345 configured to adhere the substrate 347 and the cover 346. The substrate 347 is formed with earths 344 around the first and the second signal detecting portions 333 and 335 and the first and second signal transmitting portions 334 and 336.

The earths 344 are formed of a conductor and are grounded. The earths 344 do not have to have an earth (ground) potential but only need to have a given constant potential. In the following description, the same is applicable to the similar components and these components are expressed as “earths 344” for the sake of convenience as well as description of other embodiments described later.

The adhesive agent 345 are injected into portions between the first and second signal detecting portions 333 and 335 and the earths 344, portions between the first and second signal transmitting portions 334 and 336 and the earths 344, and the peripheral portions of the earth 344 to adhere the substrate 347 and the cover 346. The substrate 347, the cover 346, and the adhesive agent 345 are formed of insulating material such as resin. For example, a polyimide substrate is employed as the substrate 347, and a polyimide film is employed as the cover 346. Therefore, as illustrated in FIG. 2A to FIG. 2D, the substrate 347, the cover 346, and the adhesive agent 345 do not have influence when detecting the latent image graduations with the probe 330.

The thicknesses of the respective portions may be as follows for example. The thickness of the substrate 347 is 25 μm, the thickness of the first and second signal detecting portions 333 and 335, the first and second signal transmitting portions 334 and 336, and the earths 344 is 9 μm, the thickness of the cover is 12 μm, and portions of the adhesive agent except for the earths 344 and the like is 15 μm. The thickness of the entire part of the latent image sensor 34 configured in this manner is preferably 50 to 70 μm. Accordingly, as described above, even though the latent image sensor 34 is held between the photoconductive drum 12 and the intermediate transfer belt 24, a contact portion between the image area of the photoconductive drum 12 and the intermediate transfer belt 24 is little affected. Consequently, the existence of the latent image sensor 34 have little influence on transfer of the toner image from the photoconductive drum 12 to the intermediate transfer belt 24.

When the clockwise rotation is defined as a positive direction, the first signal detecting portion 333 forms an angle of 45° (first angle) with respect to the direction of rotation (direction of conveyance) of the photoconductive drum 12 and the intermediate transfer belt 24, and the second signal detecting portion 335 forms an angle of −45° (second angle) with respect to the direction of rotation (direction of conveyance) of the photoconductive drum 12 and the intermediate transfer belt 24, whereby the both form an angle of 90° therebetween. These angles are not limited to values described above as long as the first signal detecting portion 333 and the second signal detecting portion 335 do not extend in parallel to each other. In any cases, the first signal detecting portion 333 is arranged in parallel to the plurality of the first lines which constitute the latent image graduations 50 described above, and the second signal detecting portion 335 is arranged in parallel to the plurality of the second lines which constitute the latent image graduations 31 described above, respectively. With the configuration of the first signal detecting portion 333 and the second signal detecting portion 335 which are not parallel to each other in the latent image sensor 34, the first signal detecting portion 333 detects only the latent image graduations 31 on the photoconductive drum 12 side, and the second signal detecting portion 335 detects only the latent image graduations 50 on the intermediate transfer belt 24 side.

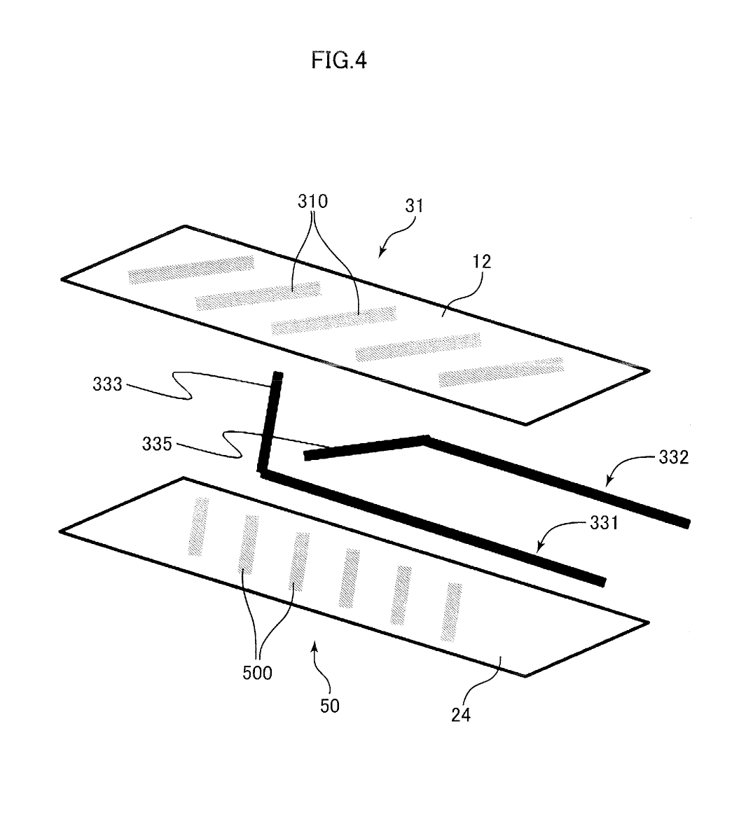

FIG. 4 illustrates the state described above. In FIG. 4, a plurality of first lines 500 which constitute the latent image graduations 50 on the intermediate transfer belt 24 side and the first signal detecting portion 333 have a parallel relationship. A plurality of second lines 310 which constitute the latent image graduations 31 on the photoconductive drum 12 side and the second signal detecting portion 335 have a parallel relationship.

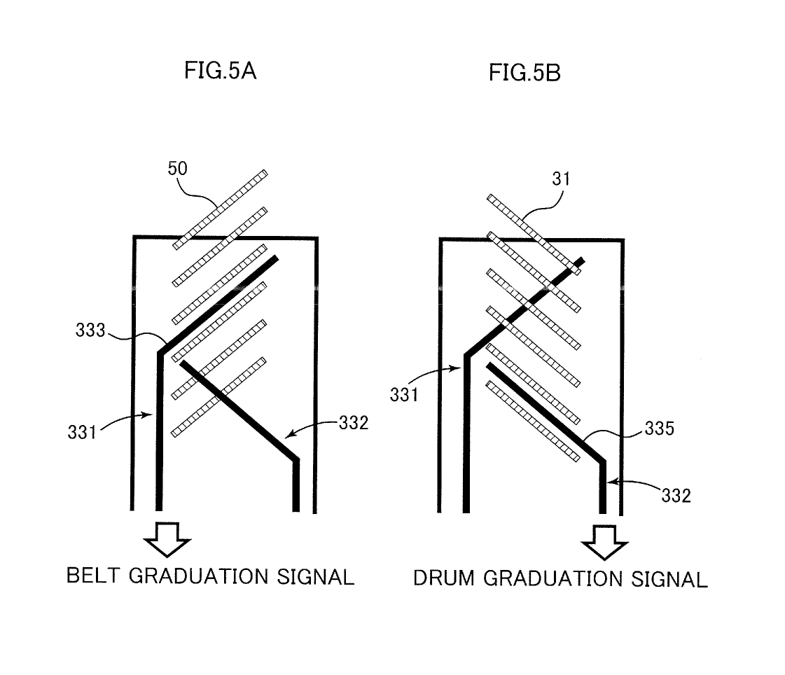

FIGS. 5A and 5B illustrate a state in which the signal detecting portions obtains respective signals only from the latent image graduations that each of the corresponding signal detecting portions should detect. Since the signal detecting portion is configured to detect only the latent image graduations which extend in parallel thereto in principle, so that acquisition of signals only from the required side is achieved as above. In other words, the first sensor portion 331 detects the latent image graduations 50 and outputs the same as a belt graduation signal, and the second sensor portion 332 detects the latent image graduations 31 and outputs the same as a drum graduation signal.

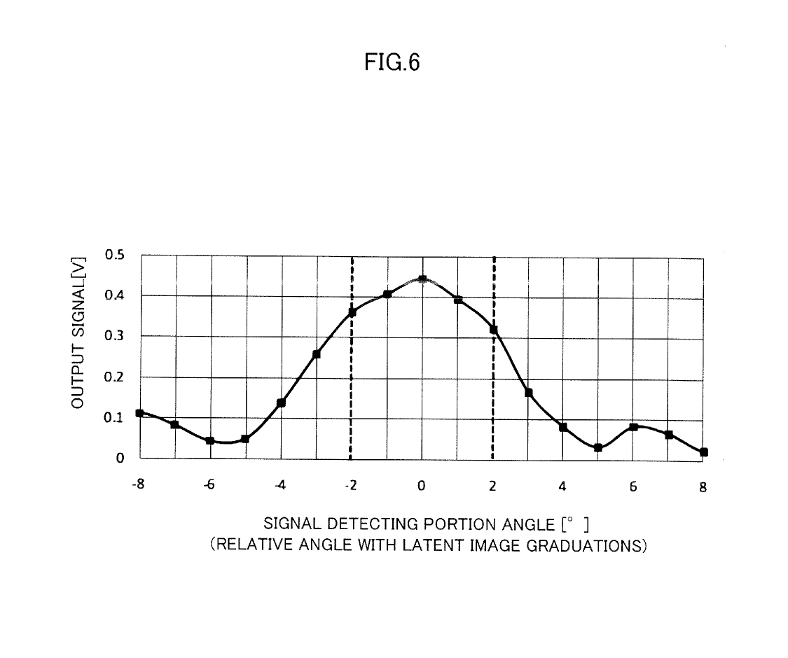

In order to obtain the relation between the angle formed between the latent image graduations and the signal detecting portion and the output signal, experimental data in which the angle of the signal detecting portion with respect to the latent image graduations is changed and the respective output signals are measured is shown in FIG. 6.

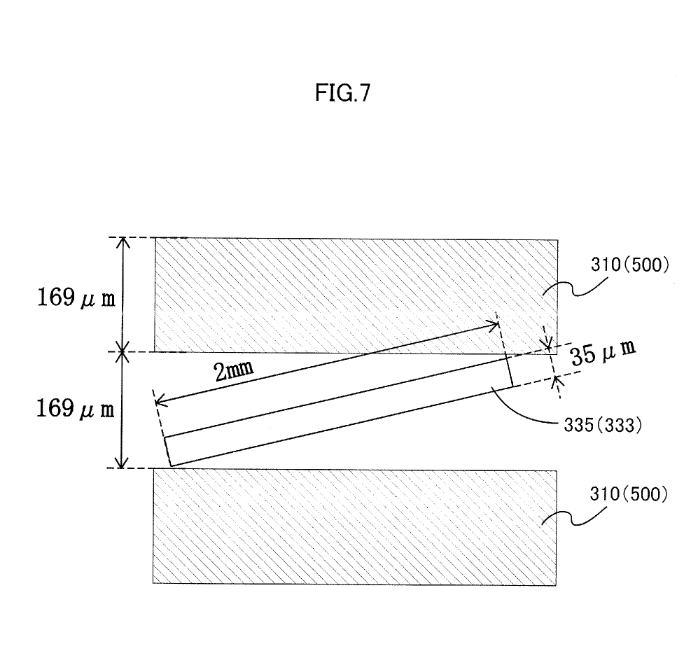

The experiment was conducted under the conditions that the signal detecting portion has a length of 2 mm and a width of 35 μm, and the latent image graduation has a pitch of 338 μm (four lines and four spaces at 600 dpi) as illustrated in FIG. 7. The latent image graduation at this time is inclined by 45° with respect to the direction of conveyance of the photoconductive drum 12 and the intermediate transfer belt 24. These dimensions are example only, and are not limited to the dimensions descried above. A range of ±2° illustrated by broken lines in FIG. 6 indicates a state in FIG. 7 in which the signal detecting portion is inclined by a maximum angle within a space between the graduation lines (the first line or the second line). It seems notionally that the signal becomes weak abruptly when the latent image graduation is inclined beyond this range. The similar tendency appears in data as well. Thus, it is preferable that an angle of inclination of the signal detecting portion 333 is set a range of ±2° from the first angle and an angle of inclination of the signal detecting portion 335 is set a range of ±2° from the second angle. Also, the second angle is shifted by at least ±2° or more from the first angle.

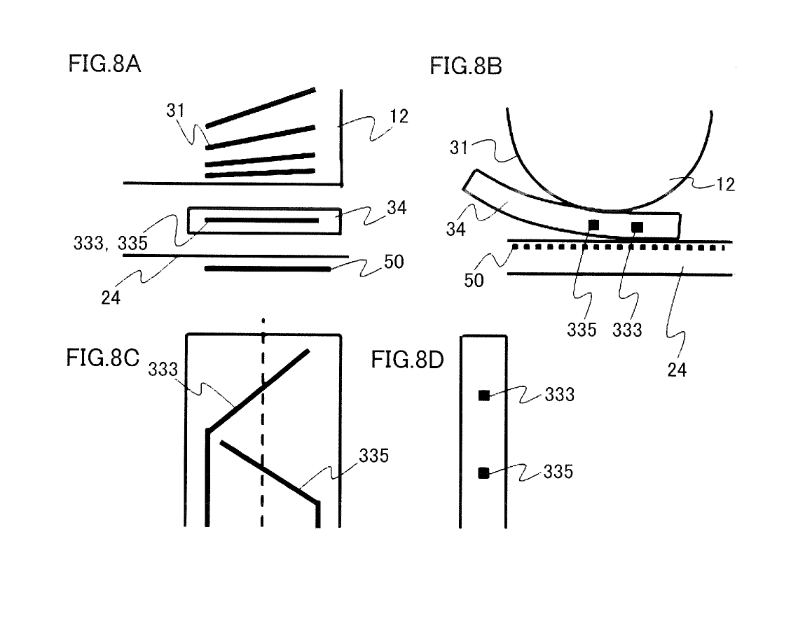

Subsequently, the state of installation of the latent image sensor 34 will be described with reference to FIG. 8. In FIG. 8, the “earths 344” in FIG. 3 are not illustrated. In other embodiments as well, the “earths 344” are omitted in the drawing illustrating the installation of the sensors. The latent image graduations 31 and the latent image graduations 50 are formed at substantially the same position in the main scanning direction (the width direction, the lateral direction in FIG. 8A and FIG. 8C). The first signal detecting portion 333 and the second signal detecting portion 335 are also drawn on the substrate 347 of the holding member 340 at substantially the same positions in the main scanning direction. In other words, the first and the second signal detecting portions 333 and 335 are held by the holding member 340 such that the first and the second signal detecting portions 333 and 33 overlap each other in the sub scanning direction (the direction of conveyance, lateral direction in FIG. 8B, the vertical direction in FIG. 8C).

The latent image sensor 34 is installed in state of being interposed between the photoconductive drum 12 and the intermediate transfer belt 24 as illustrated in FIG. 8B. The first signal detecting portion 333 is installed so as to be parallel to the latent image graduations 50 of the intermediate transfer belt 24, and the second signal detecting portion 335 is installed so as to be parallel to the latent image graduations 31 of the photoconductive drum 12. In FIG. 4 and FIGS. 5A and 5B, a state in which the signal detecting portions and the latent image graduations are in parallel to each other. As illustrated in cross section FIG. 8B, the first signal detecting portion 333 and the second signal detecting portion 335 are arranged at a nip position (the primary transfer portion T1).

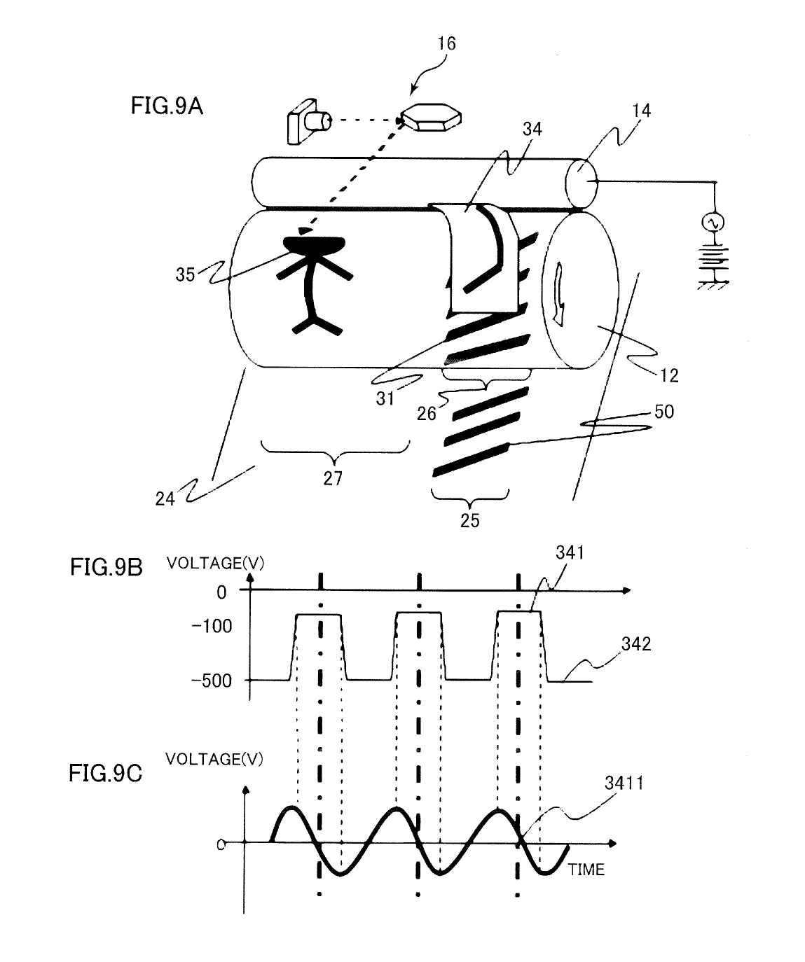

Subsequently, the detection of the latent image graduations 31 on the photoconductive drum 12 in FIG. 9 will be described in detail. The surface of the photoconductive drum 12 is charged by the charging roller 14 to a predetermined potential, and then is exposed by an exposure device 16. Subsequently, the electrostatic latent image 35 on the basis of the image information is formed in the image area 27 and the latent image graduations 31 is formed in the non-image area 26, on the photoconductive drum 12. The electrostatic latent image 35 is developed by a developing device, which is not illustrated, and becomes a toner image.

The surfaced potential of the non-image area 26 of the photoconductive drum 12 has the same a value as the image area 27. In other words, the waveform of the latent image graduations 31 is a square wave having a low-potential portion 342 of −500V and a high-potential portion 341 of −100 V, which is a waveform illustrated in FIG. 9B. The surface potential of the square wave is detected by the latent image sensor 34 as sinusoidal waveform having an amplitude centered at 0(V) as illustrated in FIG. 9C. The zero-cross points 3411 in FIG. 9C can be detected as centers of the latent image graduations 31 in the width direction. In FIG. 9A, only the sensor portion of the latent image sensor 34 on the photoconductive drum side is illustrated and a state in which the intermediate transfer belt 24 is not interposed therebetween is illustrated for the sake of convenience.

In the same manner, the shape of distribution of the surface potential of the latent image graduations 50 transferred to the intermediate transfer belt 24 also have a shape based on that illustrated in the FIG. 9B and the shape of the output waveform thereof is based on that illustrated in FIG. 9C, so that detection of the centers of the latent image graduations 50 in the width direction is achieved.

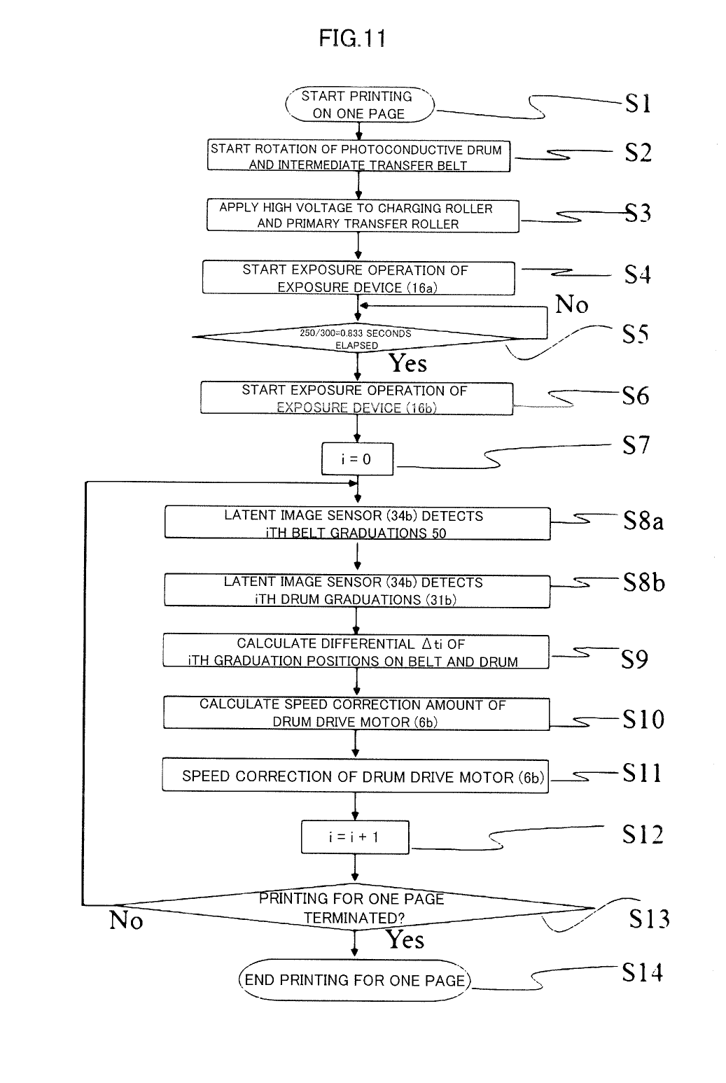

Subsequently, detailed alignment control of the toner images by using the above-described latent image graduations according to the embodiment will be described with reference to FIG. 10 and FIG. 11. In FIG. 10, in order to facilitate the description, only the relation between the image forming portions 43a and 43b is illustrated. However, the same applies to the image forming portions 43c and 43d in FIG. 1.

As illustrated in FIG. 10, the photoconductive drums 12a and 12b are rotated by drum drive motors 6a and 6b, respectively. Drum encoders 8a and 8b are provided on the drum drive motors 6a and 6b, and a control portion 48 controls the speed of rotation of the drum drive motors 6a and 6b on the basis of signals from the drum encoders 8a and 8b.

The latent image graduations 31a as the first positional information are written on the photoconductive drum 12a in the non-image areas of the toner image on the outside of the image area (developing area) in the main scanning direction by using the exposure unit 16a simultaneously with the electrostatic latent image (first latent image) on the basis of the image information. In the same manner, the latent image graduations 31b as second positional information are written on the photoconductive drum 12b in the non-image areas on the outside of the image area in the main scanning direction by using the exposure unit 16b simultaneously with the electrostatic latent image (second latent image) on the basis of the image information.

A toner of a first color (yellow) is transferred from the developing device, which is not illustrated, to a first latent image on the photoconductive drum 12a. However, the toner of the first color is not transferred to the latent image graduations 31a. In this state, “the first latent image is transferred as the toner image of the first color”, and “the latent image graduations 31a are transferred yet in the state of the electrostatic latent image” from the photoconductive drum 12a to the intermediate transfer belt 24 at the same position in the sub scanning direction. The “toner image of the first color” and the “latent image graduations 50 with the latent image graduations 31a transferred thereon” on the intermediate transfer belt 24 move to the nip position which comes into contact with the photoconductive drum 12b.

The latent image sensor 34b is installed at the nip position sandwiched between the photoconductive drum 12b and the intermediate transfer belt 24, and detects “the latent image graduations 31b and the latent image graduations 50”. The control portion 48 as a control portion controls the drum drive motor 6b configured to rotate the photoconductive drum 12b on the basis of the result of detection of the latent image sensor 34b. Accordingly, a toner image of a second color (magenta) of the photoconductive drum 12b is transferred so as to be superimposed on the toner image of the first color transferred from the photoconductive drum 12a to the intermediate transfer belt 24. In other words, the latent image graduations 50 are read by the first sensor portion 331 of the latent image sensor 34b, and the latent image graduations 31b are read by the second sensor portion 332 (see FIG. 4 and so forth). The control portion 48 controls the rotation of the photoconductive drum 12b so that the toner image of the second color match the position of the toner image of the first color when the toner image of the second color is transferred from the photoconductive drum 12b to the intermediate transfer belt 24 on the basis of the read information.

Further detailed description will be given with reference to a flowchart in FIG. 11. The control portion 48 activates drum drive motors 6a and 6b and a belt drive motor, not illustrated (S2) upon reception of a print start signal (S1). The control portion 48 controls the rotation of the drum drive motors 6a and 6b to rotate the photoconductive drums 12a and 12b in the direction of the arrow R1 at the constant speed while reading signals from the drum encoders 8a and 8b which are directly connected to a drum drive shaft. In the same manner, a belt drive motor is driven to rotate at the constant speed to rotate the intermediate transfer belt 24 in the direction of an arrow R2 via a belt drive roller 36 at a fixed speed.

Subsequently, the control portion 48 applies a charging voltage to a charging rollers 14a and 14b to charge the surfaces of the photoconductive drums 12a and 12b to, for example, −600 V. A predetermined voltage set in advance is applied to the primary transfer rollers 4a and 4b (S3).

Subsequently, the control portion 48 causes the exposure unit 16a to start exposure operation upon reception of the image signal (S4). The latent image graduations 31a are formed at a predetermined pitch from a blank space at the leading edge. When the exposure operation of an image data is started, the exposure operation is continued until the image data corresponding to one page together with the latent image graduations 31a is terminated.

Subsequently, the control portion 48 cause the exposure unit 16b to start the exposure operation (S6) when 0.833 second has elapsed from the start of the exposure operation (Yes of S5) by the exposure unit 16a. In this embodiment, the outer diameter of the photoconductive drum is set to 84 mm, and a pitch between the image forming portion 43a and the image forming portion 43b (the station-to-station pitch) is set to 250 mm. An exposure-transfer distance from the exposure position on the surface of the photoconductive drum to the position where the toner image is transferred to the intermediate transfer belt is set to 125 mm, and the process speed is set to 300 mm/sec. Then, 0.833 seconds is determined so as to correspond to time required for the intermediate transfer belt 24 to be conveyed from the position at which the toner image is transferred from the photoconductive drum 12a to the intermediate transfer belt 24 to the position at which the toner image is transferred from the photoconductive drum 12b to the intermediate transfer belt 24.

Subsequently, the control portion 48 set a count i to zero (S7). The control portion 48 detects the i^{th} (i=0) latent image graduation (belt graduation) 50 and the latent image graduation (drum graduation) 31b by the latent image sensor 34b (S8a, S8b). From the time difference from the detected “signal timing of the belt graduations 50” and “signal timing of the drum graduation 31b”, a color shift corresponding amount Δti is obtained (S9).

Subsequently, the control portion 48 calculates the amount of correction of the speed of the drum drive motor 6b of the image forming portion 43b so that the positional shift between the “latent graduations 31b on the photoconductive drum 12b” and the “latent image graduation 50 on the intermediate transfer belt 24” is eliminated on the basis of Δti (S10). The control portion 48 corrects the speed of rotation of the drum drive motor 6b by a calculated amount of correction (S11). The control portion 48 controls so that the speed of rotation of the drum drive motor 6b is corrected to reduce the positional shift between the graduations.

The control portion 48 repeats the control of the drum drive motor 6b until image data corresponding to one page is terminated, and terminates printing for one page (S13).

The control portion 48 aligns the positions of the drum graduations 31b, 31c, and 31d corresponding to the toner images at the image forming portions 43b, 43c, and 43d with the electrostatic latent image graduations 50 corresponding to the toner images that are primarily transferred at the image forming portion 43a. Accordingly, since the toner images can be transferred at the image forming portions 43b, 43c, and 43d on the toner image formed on the intermediate transfer belt 24 so as to be superimposed with high degree of accuracy, output of a high-quality full color image without any color shift is achieved.

As described above, the positions of the photoconductive drums 12b, 12c and 12d with respect to the intermediate transfer belt 24 are varied in accordance with the calculated shift amounts so as to avoid the shifts between the latent image graduations of the corresponding photoconductive drums and the intermediate transfer belt. Accordingly, a correction of high degree of accuracy is enabled also for the positional shift of the toner images due to expansion or contraction of the intermediate transfer belt 24 generated by the transfer of the toner image on the intermediate transfer belt 24. For example, as a result of controlling the color shift on the basis of the first embodiment, the amount of color shifts among four colors of toner could be reduced from 150 μm of the related art to 40 μm.

In the case of the first embodiment, the first sensor portion 331 and the second sensor portion 332 integrally held by the holding member 340. In other words, the sensor portion configured to read the latent image graduations on the photoconductive drum side and the sensor portion configured to read the latent image graduations on the intermediate transfer belt side are held integrally by the holding member 340 without being separated from each other. Therefore, the cause of errors when aligning the images such as variations due to a temperature change of relative positions between sensor portions or difference in vibrations of the respective information detecting portions may be reduced.

The holding member 340 is arranged so as to be held between the photoconductive drum and the intermediate transfer belt. Therefore, even when the first sensor portion 331 and the second sensor portion 332 are held integrally, the latent image graduations 50 formed on the intermediate transfer belt and the latent image graduations 31 formed on the photoconductive drum 12 are read by the respective sensors. In other words, in the first embodiment, the latent image sensor 34 holds the first sensor portion 331 and the second sensor portion 332 integrally by the holding member. Therefore, the positions where the latent image graduations 31 on the photoconductive drum 12 and the latent image graduations 50 on the intermediate transfer belt 24 can be read accurately are located between the photoconductive drum 12 and the intermediate transfer belt 24 such that the sensor portions can be arranged in contact with or in proximity to both simultaneously. With the configuration and operation as described above, the first embodiment achieves a high-quality image output in which the color shift is reduced.

In the first embodiment, the first signal detecting portion 333 which constitutes the first sensor portion 331 and the second signal detecting portion 335 which constitutes the second sensor portion 332 are held such that the first and second signal detecting portion 333 and 335 overlap each other when viewed in the direction of conveyance. In other words, the latent image graduations can be detected at substantially the same positions in the width direction intersecting the direction of conveyance of the photoconductive drum 12 and the intermediate transfer belt 24. Therefore, detection of the latent image graduations 31 and 50 formed at substantially the same position in the width direction is achieved.

### Second Embodiment

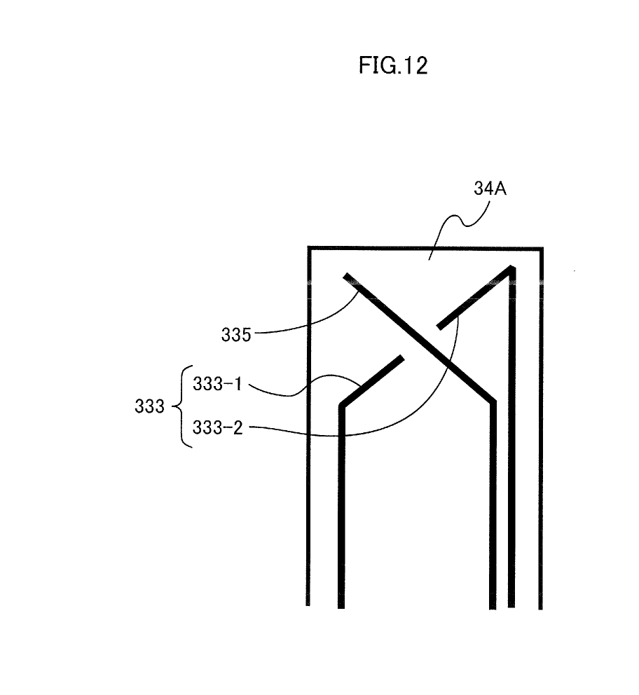

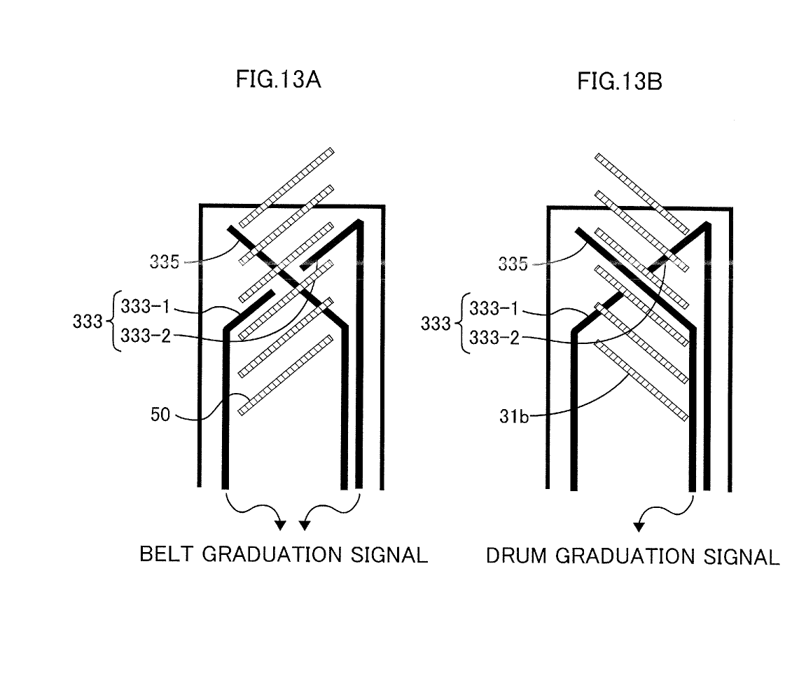

Referring now to FIG. 12 and FIGS. 13A and 13B, a second embodiment of this disclosure will be described. In the first embodiment described above, as is clear from FIG. 8C for example, the first signal detecting portion 333 and the second signal detecting portion 335 of the latent image sensor 34 are not formed at the same position in the sub scanning direction to be exact. In contrast, in a latent image sensor 34A of the second embodiment, the first signal detecting portion 333 and the second signal detecting portion 335 are arranged at the same position in the sub scanning direction.

In other words, the first signal detecting portion 333 which functions as the first information detecting portion and the second signal detecting portion 335 which functions as the second information detecting portion divide one of the information detecting portions (signal detecting portions) into two parts. The first signal detecting portion 333 and the second signal detecting portion 335 are arranged so as to be superimposed when viewed in the width direction (main scanning direction) that intersects the direction of conveyance by arranging divided two parts of one of the information detecting portions so as to arrange the other information detecting portions therebetween in the direction of conveyance. In the second embodiment, the first signal detecting portion 333 and the second signal detecting portion 335 are positioned at substantially the same positions in the direction of conveyance (the sub scanning direction). The first signal detecting portion 333 is divided into two first and second signal detecting elements 333-1 and 333-2. The second signal detecting portion 335 is interposed between the first and second signal detecting elements 333-1 and 333-2 to achieve a positional relationship in which the first and second signal detecting portions 333 and 335 intersect with each other in FIG. 12.

As the second embodiment, the latent image sensor 34A manufactured by using a single layer flexible printed board, the solid intersection of the signal detecting portions cannot be achieved, so that the second signal detecting portion 335 is divided into two parts to achieve the above-described arrangement relationship. The second signal detecting portion 335 reads the latent image graduations 31 on the photoconductive drum side in the same manner in the first embodiment as illustrated in FIG. 13B. The first signal detecting portion 333 divided into two parts illustrated in FIG. 12 reads the latent image graduations on the intermediate transfer belt side by the first and second signal detecting elements 333-1 and 333-2 as illustrated in FIG. 13A. The output signals of the first and second signal detecting elements 333-1 and 333-2 are added (simply connected electrically), so that the output signal as in the first embodiment is obtained.

When the signal detecting portions are configured as in FIG. 12, the length of the signal detecting portion which needs to be interposed is half the length in the first embodiment, and accurate detection of the graduations on the drum and the belt at the same position in the sub scanning direction is achieved. Other configurations and operations are the same as in the first embodiment described above.

### Third Embodiment

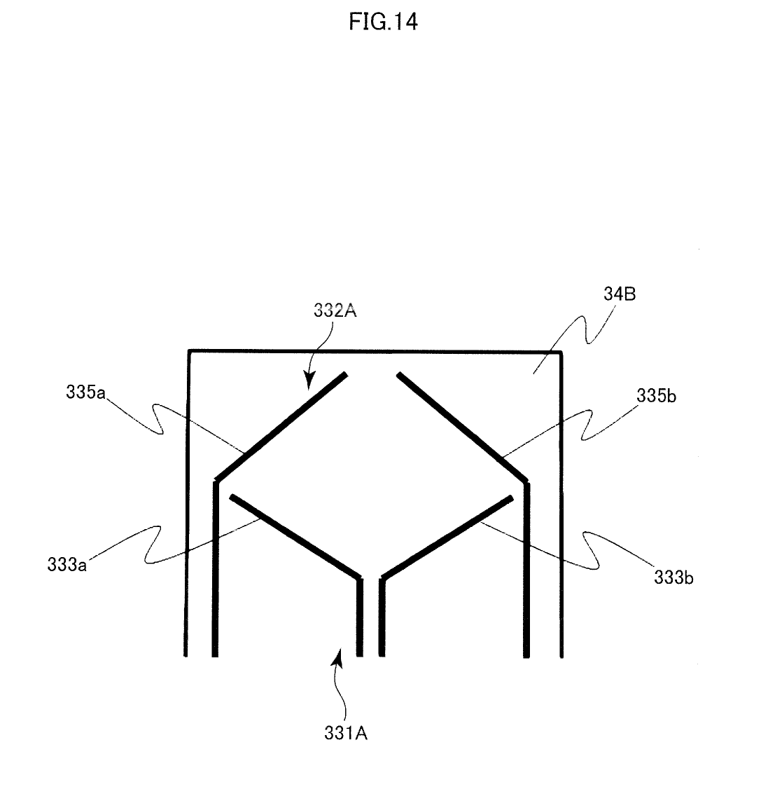

Referring now to FIG. 14 to FIG. 19, a third embodiment of this disclosure will be described. In the first and the second embodiment described above, detection of the color shift in the sub scanning direction is intended. However, the color shift is generated also in the main scanning direction, and the direction of the color shift in the main scanning direction cannot be determined with the sensor configurations described in the first and the second embodiments. Therefore, the third embodiment is intended to detect the color shift in the main scanning direction in addition to the color shift in the sub scanning direction.

The latent image sensor 34B of the third embodiment includes a first sensor portion 331A having two signal detecting portions (first and third signal detecting portions) 333a and 333b and a second sensor portion 332A having two signal detecting portions (second and fourth signal detecting portions) 335a and 335b. The first and third signal detecting portions 333a and 333b of the first sensor portion 331A are formed substantially at the same position in the direction of conveyance (the sub scanning direction) at different positions in the width direction (the main scanning direction) intersecting the direction of conveyance of the photoconductive drum and the intermediate transfer belt. In addition, the first and third signal detecting portions 333a and 333b have different angles of inclination in the sub scanning direction. The second and fourth signal detecting portions 335a and 335b of the second sensor portion 332A are formed at positions different from each other in the main scanning direction and substantially the same positions in the sub scanning direction, and also have different angles of inclination in the sub scanning direction. In other words, the third signal detecting portion 333b is formed in line symmetry with respect to the first signal detecting portion 333a in the width direction interesting the direction of conveyance. The fourth signal detecting portion 335b is formed in line symmetry with respect to the second first signal detecting portion 335a in the width direction interesting the direction of conveyance.

The first signal detecting portion 333a of the first sensor portion 331A and the second signal detecting portion 335a of the second sensor portion 332A, and the third signal detecting portion 333b and the fourth signal detecting portion 335b are formed at substantially the same position in the main scanning direction. In other words, the first and third signal detecting portions 333a and 333b of the first sensor portion 331A and the second and fourth signal detecting portions 335a and 335b of the second sensor portion 332A are arrange so as to be overlapped each other when viewed in the sub scanning direction.

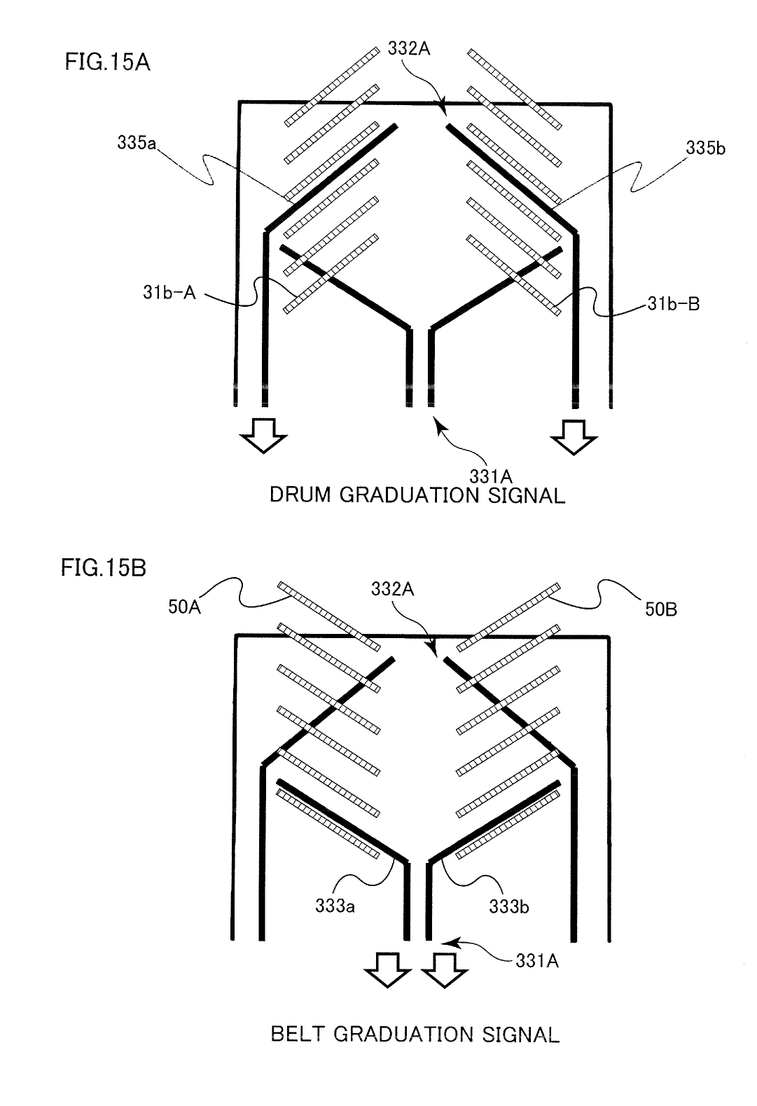

In contrast, two types each of the latent image graduations formed on the second image carrier 12b and the intermediate transfer belt are formed as illustrated in FIGS. 15A and 15B. In other words, as illustrated in FIG. 15A, the photoconductive drum is formed with the latent image graduations 31A and 31B having different angles of inclination with respect to the sub scanning direction. The inclination of the lines of the latent images which constitute the latent image graduations 31A and 31B is substantially the same as the inclination of the signal detecting portions 335a and 335b of the second sensor portion 332A, respectively. In other words, the second latent image graduations 31b-A and the forth latent image graduations 31b-B formed in line symmetry with the second latent image graduations 31b-A in the width direction are formed on the surface of the second image carrier 12b by a second exposure device 16b. Therefore, the signal detecting portion 335a detects the latent image graduations 31b-A and the signal detecting portion 335b detects the latent image graduations 31b-B respectively.

As illustrated in FIG. 15B, the intermediate transfer belt is formed with the latent image graduations 50A and 50B having angles of inclination different from each other in the sub scanning direction. The inclination of the lines of the latent images which constitute the latent image graduations 50A and 50B is substantially the same as the inclination of the signal detecting portions 333a and 333b of the first sensor portion 331A. That is, a latent image graduation 31a-A to be the first latent image graduation and a latent image graduation 31a-B to be the third latent image graduation are formed on the first image carrier 12a by the first exposure unit 16a. The latent image graduation 31a-B is formed in line symmetry with the latent image graduation 31a-A and theses latent image graduations 31a-A and 31a-B are transferred respectively on the surface of the intermediate transferred belt 24 to form the first latent image graduation 50A and the third latent image graduation 50B on the surface of the intermediate transferred belt 24. Therefore, the signal detecting portion 333a detects the latent image graduations 50A and the signal detecting portion 333b detects the latent image graduations 50B respectively.

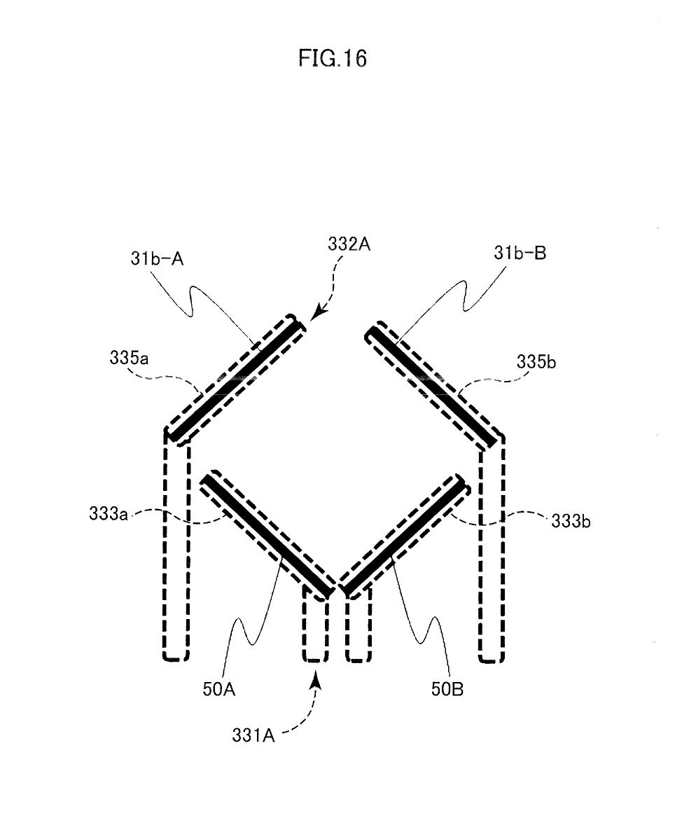

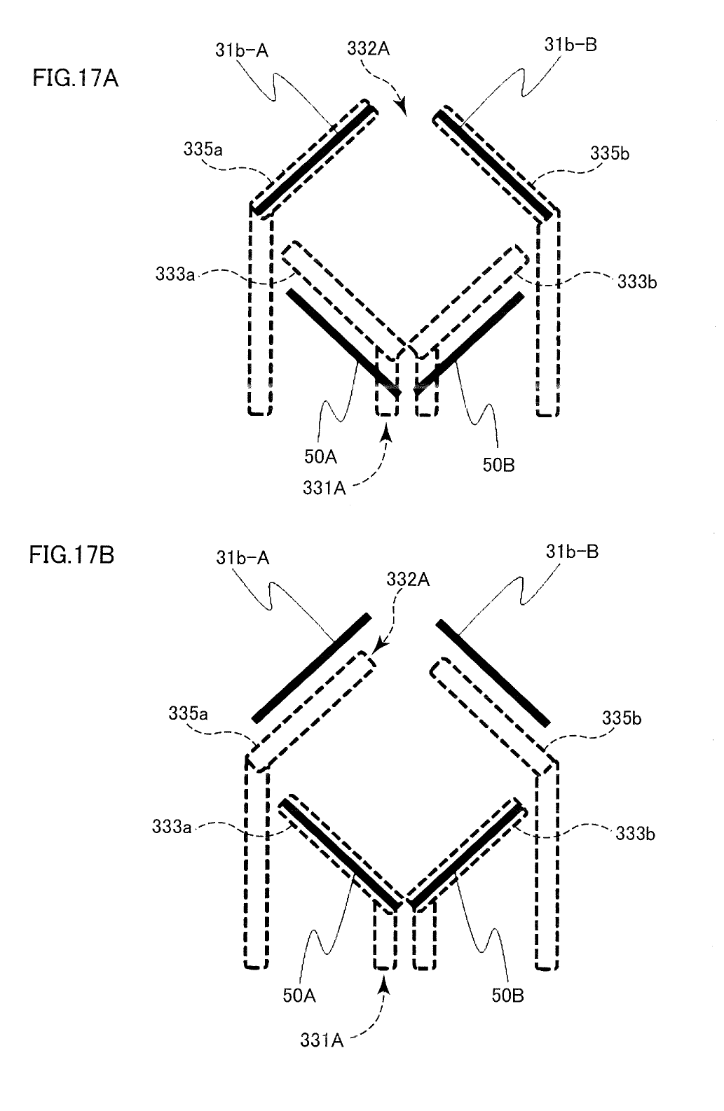

How the color shift generated in the main scanning direction and the sub scanning direction can be detected will be described below. FIG. 16, FIGS. 17A and 17B, FIGS. 18A to 18C, and FIG. 19 illustrate occurrence of a color shift in the primary and the secondary directions and how the color shift is detected.

FIG. 16 illustrates a state in which no color shift occurs in the main scanning direction and the sub scanning direction, and the latent image graduations are detected simultaneously in all of the first and third signal detecting portions 333a and 333b and the second and fourth signal detecting portions 335a and 335b.

FIG. 17A illustrates a state in which a color shift occurs only in the sub scanning direction. In FIG. 17A, the second signal detecting portion 335a and the fourth signal detecting portion 335b detect the latent image graduations 31b-A and the latent image graduations 31b-B simultaneously. After the movement by a distance (after the elapse of time) corresponding to the color shift, the first signal detecting portion 333a and the third signal detecting portion 333b detect the first latent image graduations 50A and the third latent image graduations 50B simultaneously in FIG. 17B. A result of multiplying the detection time difference by a process speed of 300 mm/sec. corresponds to the distance of the color shift in the sub scanning direction.

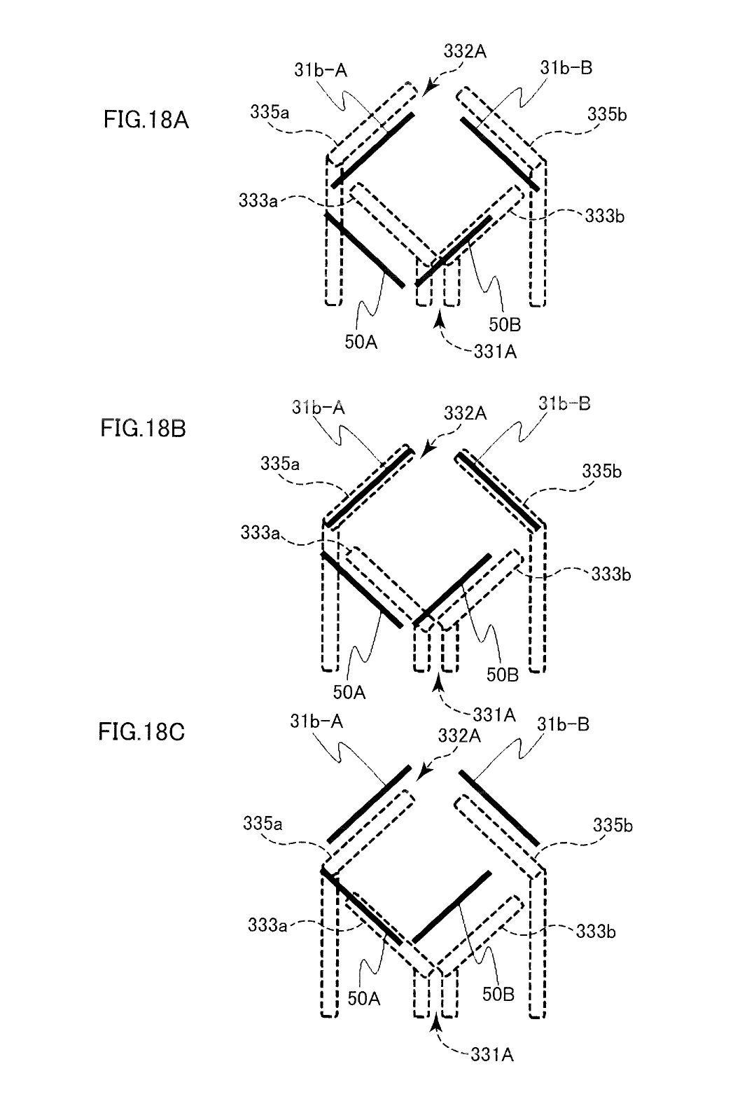

FIGS. 18A to 18C illustrate a state in which a color shift occurs only in the main scanning direction. In FIG. 18A, the third signal detecting portion 333b detects the fourth latent image graduations 50B. Subsequently, after the movement by a certain fixed distance L1 (after the elapse of time), the signal detecting portion 335a and the signal detecting portion 335b detect the latent image graduations 31b-A and the latent image graduations 31b-B simultaneously in FIG. 18B. Furthermore, after the movement by a certain fixed distance L2 (after the elapse of time) the first signal detecting portion 333a detects the second latent image graduations 50A in FIG. 18C.

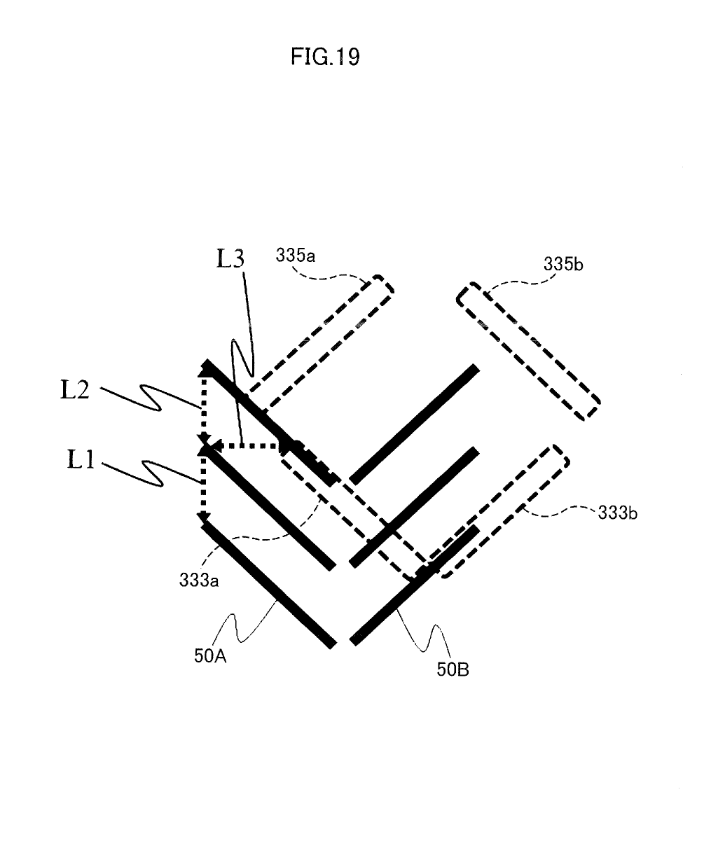

Here, a relationship between a “certain fixed distances L1 and L2” and a “distance of the color shift in the main scanning direction” is illustrated in FIG. 19. In FIG. 19, the movements of the latent image graduations 50A and 50B in FIGS. 18A, 18B, and 18C are illustrated in a superimposed manner, and the distance of the color shift in the main scanning direction becomes L3. In the case of this embodiment, the angle of the latent image graduations is illustrated to form an angle of 45° with respect to the direction of conveyance of the photoconductive drum in the same manner as in the first embodiment. Therefore, in FIG. 19, triangles formed of “L1 and L3” and “L2 and L3” in FIG. 19 are isosceles triangles having angles of 90°, 45°, and 45°. Therefore, the expression L1=L2=L3 is satisfied, and the “certain fixed distances L1 and L2” and the “distance L3 of the color shift in the main scanning direction” are equal. A result of multiplying the detection time difference (the time required for a movement by a certain fixed distance L1) by a process speed of 300 mm/sec. corresponds to the distance of the color shift in the main scanning direction.

In the case of the third embodiment, with the configuration and operation as described above, detection of the color shift in the main scanning direction and the sub scanning direction is enabled. Therefore, the control portion 48 (FIG. 10) controls the exposure unit 16b of the image forming portion 43b upon detection of the color shift in the main scanning direction, whereby the color shift is reduced by shifting the exposure position of the electrostatic latent image formed on the photoconductive drum 12b in the main scanning direction by an amount corresponding to the shift amount. Other configurations and operations are the same as in the first embodiment described above.

### Fourth Embodiment

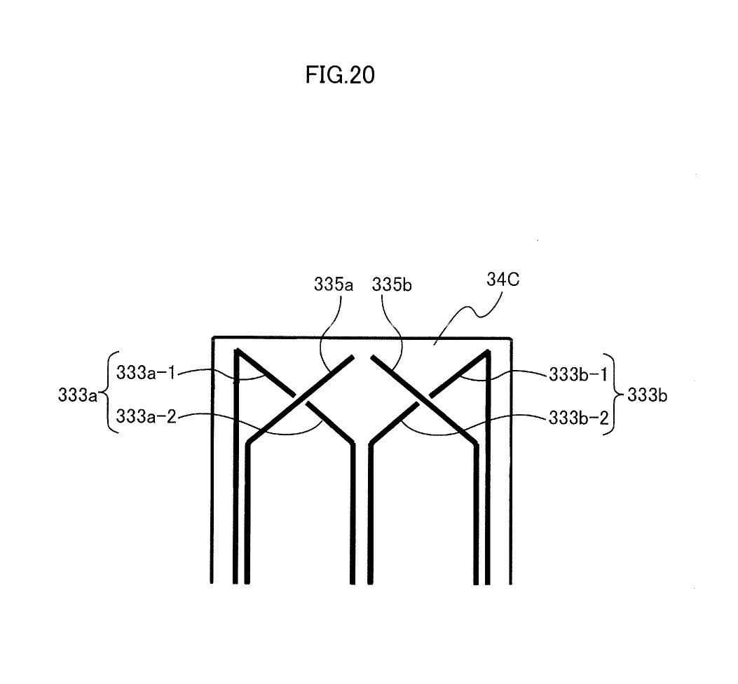

Referring now to FIG. 20, a fourth embodiment of this disclosure will be described. The second embodiment described above is a modification of the first embodiment and configured to allow detection in the short range in the sub scanning direction and detection of the graduations on the drum and the belt at the accurately same position in the sub scanning direction. The third embodiment is a modification of the first embodiment so as to cope with the shift in the main scanning direction. The fourth embodiment has a configuration in which the modifications in the second and the third embodiments are applied to the first embodiment simultaneously.

As illustrated in FIG. 20, in the latent image sensor 34C of the fourth embodiment, the first signal detecting portion 333a and the second signal detecting portion 335a, and the third signal detecting portion 333b and the fourth signal detecting portion 335b are each arranged at the same position in the sub scanning direction. Therefore, the first and third signal detecting portions 333a and 333b each are divided into two parts. In other words, the first signal detecting portion 333a is divided into two signal detecting elements 333a-1 and 333a-2 and the third signal detecting portion 333b is divided into two signal detecting elements 333b-1 and 333b-2.

The signal detecting elements 333a-1 and 333a-2 are arranged so as to have the second signal detecting portion 335a therebetween and the signal detecting elements 333b-1 and 333b-2 are arranged so as to have the fourth signal detecting portion 335b therebetween in the direction of conveyance (the sub scanning direction). Accordingly, the first signal detecting portion 333a and the second signal detecting portion 335a are arranged so as to be overlapped on the third signal detecting portion 333b and the fourth signal detecting portion 335b respectively when viewed from the width direction (main scanning direction). In the fourth embodiment, the first and third signal detecting portions 333a and 333b and the second and fourth signal detecting portions 335a and 335b are all formed at substantially the same position in the sub scanning direction.

In the case of the fourth embodiment configured in this manner, the latent image graduations can be detected in a short range in the sub scanning direction, the latent image graduations on the photoconductive drum and the intermediate transfer belt accurately at the same position in the sub scanning direction, and the color shift in the main scanning direction and the sub scanning direction can be detected. Other configurations and advantages are the same as the first, the second, and the third embodiments described above.

### Other Embodiments

In the embodiments described thus far, the configuration in which the intermediate transfer belt is employed as the conveying member. However, this disclosure is also applicable to a configuration in which a recording medium conveying belt configured to convey the recording medium is employed as the conveying member and the toner images are transferred from the photoconductive drums directly to a recording medium. In this case, the toner images are transferred to the recording medium, but the latent image graduations as the first positional information are transferred to the recording medium conveying belt.

In the embodiments described thus far, the rotation of the photoconductive drum 12 as the second image carrier is controlled to correct the color shift in the sub scanning direction. However, the correction of the color shift as described above may be performed by other methods, for example, by control of an exposure timing of the exposure device in the second image forming portion or by control of the speed of conveyance of the conveying member such as the intermediate transfer belt and the recording medium conveying belt. What is essential is that the correction of the color shift is achieved by controlling at least one of the second image carrier, the second image forming portion, and the conveying member.

In the embodiments described thus far, the first positional information to be formed on the intermediate transfer belt is formed by transferring the latent image graduations 31a formed on the photoconductive drum 12a as the first image carrier to the intermediate transfer belt 24. However, such first positional information may be formed directly on the intermediate transfer belt or the recording medium conveying belt. The first positional information and the second positional information are not limited to the latent image graduations formed of the electrostatic latent image, and may be magnetic graduations formed by magnetism. In this case, the first information detecting portion and the second information detecting portion are configured to detect changes of the magnetism.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-029574, filed Feb. 19, 2013, which is hereby incorporated by reference herein in its entirety.

What is claimed is:

1. An image forming apparatus comprising:
a conveying member configured to carry and convey an image or a recording medium;
a first image carrier and a second image carrier arranged in a direction of conveyance of the conveying member and each configured to carry and convey an image;
a first image forming portion configured to form an image on the first image carrier;
a second image forming portion configured to form an image on the second image carrier;
a first transfer portion configured to transfer an image from the first image carrier to the conveying member or the recording medium conveyed by the conveying member;
a second transfer portion arranged downstream of the first transfer portion in the direction of conveyance of the conveying member, and configured to transfer an image from the second image carrier to the conveying member or the recording medium conveyed by the conveying member;
a first positional information forming unit configured to form first positional information relating to a position of the image formed by the first image forming portion on the conveying member;
a second positional information forming unit configured to form second positional information relating to a position of the image formed by the second image forming portion on the second image carrier;
a first information detecting portion arranged so as to incline with respect to the direction of conveyance of the conveying member and configured to detect the first positional information formed on the conveying member;
a second information detecting portion arranged so as to incline with respect to the direction of conveyance of the second image carrier and configured to detect the second positional information formed on the second image carrier;
a control portion configured to control at least any one of the second image carrier, the second image forming member, and the conveying member such that the position of the image carried on the second image carrier matches the position of the image transferred from the first image carrier to the conveying member or the image transferred from the first image carrier to the recording medium conveyed by the conveying member when the image is transferred from the second image carrier to the conveying member or the recording medium conveyed by the conveying member on the basis of the first positional information detected by the first information detecting portion and the second positional information detected by the second information detecting portion; and
a holding member arranged so as to be interposed between the second image carrier and the conveying member and configured to hold the first information detecting portion and the second information detecting portion integrally.

2. The image forming apparatus according to claim 1, wherein the first positional information forming unit includes a first positional information forming portion configured to form the first positional information on the first image carrier and an information transfer portion configured to transfer the first positional information formed on the first image carrier to the conveying member.

3. The image forming apparatus according to claim 2, wherein the first transfer portion also functions as the information transfer portion.

4. The image forming apparatus according to claim 2, wherein the first image forming portion includes a first charging portion configured to charge a surface of the first image carrier, a first exposure device configured to expose the surface of the first image carrier charged by the first charging portion to form an electrostatic latent image, and a first developing device configured to develop the electrostatic latent image formed on an image area on the first image carrier to form the image,
the second image forming portion includes a second charging portion configured to charge a surface of the second image carrier, a second exposure device configured to expose the surface of the second image carrier charged by the second charging portion to form an electrostatic latent image, and a second developing device configured to develop the electrostatic latent image formed on an image area on the second image carrier to form the image,
the first positional information forming unit is configured to form an electrostatic latent image, which functions as the first positional information, by the first exposure device, which functions as the first positional information forming portion, on a non-image area on the surface of the first image carrier out of the image area shifted in the width direction intersecting the direction of conveyance of the first image carrier, and to transfer the electrostatic latent image, which functions as the first positional information to the conveying member by the information transfer portion,
the second positional information forming unit is configured to form an electrostatic latent image, which functions as the second positional information, by the second exposure device on a non-image area on the surface of the second image carrier out of the image area shifted in the width direction intersecting the direction of conveyance of the second image carrier, and
the holding member is arranged between the non-image area on the second image carrier and a non-image area on the conveying member to which the first positional information formed in the non-image area on the first image carrier is transferred.

5. The image forming apparatus according to claim 3, wherein the first image forming portion includes a first charging portion configured to charge a surface of the first image carrier, a first exposure device configured to expose the surface of the first image carrier charged by the first charging portion to form an electrostatic latent image, and a first developing device configured to develop the electrostatic latent image formed on an image area on the first image carrier to form the image,
the second image forming portion includes a second charging portion configured to charge a surface of the second image carrier, a second exposure device configured to expose the surface of the second image carrier charged by the second charging portion to form an electrostatic latent image, and a second developing device configured to develop the electrostatic latent image formed on an image area on the second image carrier to form the image,
the first positional information forming unit is configured to form an electrostatic latent image, which functions as the first positional information, by the first exposure device, which functions as the first positional information forming portion, on a non-image area on the surface of the first image carrier out of the image area shifted in the width direction intersecting the direction of conveyance of the first image carrier, transfer the electrostatic latent image, which functions as the first positional information to the conveying member by the information transfer portion,
the second positional information forming unit is configured to form an electrostatic latent image, which functions as the second positional information, by the second exposure device on a non-image area on the surface of the second image carrier out of the image area shifted in the width direction intersecting the direction of conveyance of the second image carrier,
the holding member is arranged between the non-image area on the second image carrier and a non-image area on the conveying member to which the first positional information formed in the non-image area on the first image carrier is transferred.

6. The image forming apparatus according to claim 4, wherein the first positional information forming unit forms the first positional information by arranging a plurality of first lines inclined at substantially a same angle with respect to the direction of conveyance of the first image carrier in the direction of conveyance of the first image carrier by the first positional information forming portion,
the second positional information forming unit forms the second positional information by arranging a plurality of second lines, not in parallel to the first lines, inclined at substantially a same angle with respect to the direction of conveyance of the second image carrier in the direction of conveyance of the second image carrier,
the first information detecting portion is arranged in substantially parallel to the first lines and detect a change of a signal output when the plurality of the first lines pass a position opposing the first information detecting portion, and
the second information detecting portion is arranged in substantially parallel to the second lines and detect a change of a signal output when the plurality of the second lines pass a position opposing the second information detecting portion.

7. The image forming apparatus according to claim 5, wherein the first positional information forming unit forms the first positional information by arranging a plurality of first lines inclined at substantially a same angle with respect to the direction of conveyance of the first image carrier in the direction of conveyance of the first image carrier by the first positional information forming portion,
the second positional information forming unit forms the second positional information by arranging a plurality of second lines, not in parallel to the first lines, inclined at substantially a same angle with respect to the direction of conveyance of the second image carrier in the direction of conveyance of the second image carrier not in parallel to the first lines,
the first information detecting portion is arranged in substantially parallel to the first lines and detect a change of a signal output when the plurality of the first lines pass a position opposing the first information detecting portion, and
the second information detecting portion is arranged in substantially parallel to the second lines and detect a change of a signal output when the plurality of the second lines pass a position opposing the second information detecting portion.

8. The image forming apparatus according to claim 1, wherein the holding member holds the first information detecting portion and the second information detecting portion such that the first information detecting portion and the second information detecting portion overlap each other when viewed in the direction of conveyance.

9. The image forming apparatus according to claim 1, wherein the holding member includes a substrate on which conductors, which serve as the first information detecting portion and the second information detecting portion, are printed on the surface thereof, a cover configured to cover the surface of the substrate, and an adhesive agent configured to adhere the substrate with the cover.

10. The image forming apparatus according to claim 8, wherein one of the first information detecting portion and the second information detecting portion is divided into two parts, and the divided one of the information detecting portions is arranged so as to interpose the other information detecting portion therebetween in the direction of conveyance to overlap each other when viewed from the width direction intersecting the direction of conveyance.

11. The image forming apparatus according to claim 1, further comprising an erasing portion arranged upstream of the first image carrier in the direction of conveyance of the conveying member and configured to erase the first positional information formed on the conveying member.

12. An image forming apparatus comprising:
a first image carrier;
a first exposure device configured to form first latent image graduations formed of an electrostatic latent image on a surface of the first image carrier so as to incline by a first angle with respect to the direction of rotation of the first image carrier;
an intermediate transfer belt to which the first latent image graduations are transferred;
a second image carrier arranged downstream of the first image carrier in the direction of conveyance of the intermediate transfer belt;
a second exposure device configured to form second latent image graduations formed of an electrostatic latent image on a surface of the second image carrier so as to incline by a second angle with respect to the direction of rotation of the second image carrier; and
a latent image sensor configured to detect the first and second latent image graduations;
wherein the latent image sensor includes
a first signal detecting portion inclined by the first angle so as to be in parallel to the first latent image graduations transferred to the intermediate transfer belt and configured to detect the first latent image graduations;
a second signal detecting portion inclined by the second angle so as to be in parallel to the second latent image graduations formed on the second image carrier and configured to detect the second latent image graduations; and
a holding member configured to hold the first signal detecting portion and the second signal detecting portion in the same layer.

13. The image forming apparatus according to claim 12, wherein the holding member holds the first signal detecting portion and the second signal detecting portion such that the first information detecting portion and the second information detecting portion overlap each other when viewed in the direction of conveyance.

14. The image forming apparatus according to claim 13, wherein the second angle is shifted by at least ±2°□□ or more from the first angle.

15. The image forming apparatus according to claim 13, wherein one of the first signal detecting portion and the second signal detecting portion is divided into two parts, and the divided one of signal detecting portions is arranged so as to interpose the other signal detecting portion therebetween in the direction of conveyance to overlap each other when viewed from the width direction intersecting the direction of conveyance.

16. The image forming apparatus according to claim 13, wherein the latent image sensor includes:
a third signal detecting portion formed in line symmetry with the first signal detecting portion in a width direction intersecting in the direction of conveyance, and
a fourth signal detecting portion formed in line symmetry with the second signal detecting portion in the width direction, and
the first exposing device forms the third latent image graduations formed in line symmetry with the first latent image graduations in the width direction on the surface of the first image carrier, and
the second exposing device forms the fourth latent image graduations formed in line symmetry with the second latent image graduations in the width direction on the surface of the second image carrier.
